(19) United States
(12) Patent Application Publication
(10) Pub. No.: US 2023/0034262 A1
(43) Pub. Date: Feb. 2, 2023

(54) PERFORMANCE DATA MANAGEMENT DEVICE AND BUSINESS MANAGEMENT SYSTEM

(71) Applicant: HITACHI, LTD., Tokyo (JP)

(72) Inventors: Hironari KURIHARA, Tokyo (JP); Fuminori HIROSE, Tokyo (JP); Kosaku IZUMI, Tokyo (JP)

(21) Appl. No.: 17/789,817

(22) PCT Filed: Sep. 17, 2020
(86) PCT No.: PCT/JP2020/035214

§ 371 Date: Jun. 29, 2022

(30) Foreign Application Priority Data
Feb. 19, 2020 (JP) 2020-026276

(51) Int. Cl. G06Q 10/06; G06Q 50/04

(52) U.S. Cl. CPC G06Q 10/0639; G06Q 50/04

(57) ABSTRACT

A performance data processing section that receives performance data generated by a manufacturing site system; a performance data storage section that stores received performance data; a master data storage section that stores master data that has data to be basic information when the performance data is managed; a business data generation section that generates business data by processing the performance data into a structure used by a business application based on data to be the basic information in the master data; and a business data storage section that stores the business data are included, in which the master data includes an attribute that represents start of an effective period of data to be the basic information and an attribute that represents end of the effective period.

### TECHNICAL FIELD

The present invention relates to a performance data management device and a business management system.

### BACKGROUND ART

Business performance data is conventionally managed by a program processed on a computer for the purpose of streamlining and improving business. The above program is referred to as business application. At a manufacturing site, a certain business application operates on a computerized information system to perform management information of performance data.

For example, PTL 1 discloses “finding a future production index value by performing a production simulation on the basis of the performance data, and, in a case where the future production index value becomes lower than the current production index value, performing a production simulation by improvement master data corrected on the basis of possible improvement master data”.

### CITATION LIST

### Patent Literature

PTL 1: JP 2017-174334 A

### SUMMARY OF INVENTION

### Technical Problem

Performance data of a manufacturing site is used in many business applications. Therefore, there is a product that manages data of a manufacturing site and cooperates with a business application without performing program modification. However, there is not a product that has a function of maintaining consistency of a change in data, manages performance data, and cooperates with a business application without a program.

In a case where a change occurs in the content of performance data managed by the business application, data inconsistency occurs unless related data is changed with consistency maintained. For example, when a name of specific data is changed, data related to this specific data refers to data after the change. In this case, for example, past data registered before the name change refers to the data after the name change, and therefore data inconsistency occurs. At a manufacturing site, since it is necessary to trace a trail from past performance data, a mechanism for changing data while ensuring consistency of past data is necessary.

The present invention has been made in view of the above circumstances, and an object thereof is to ensure consistency of related data even when a change occurs in content of performance data of a manufacturing site system.

### Solution to Problem

In order to solve the above problem, a performance data management device of one aspect of the present invention includes: a performance data processing section that receives performance data generated by a manufacturing site system; a performance data storage section that stores and accumulates the performance data received by the performance data processing section; a master data storage section that stores master data that has data to be basic information when the performance data is managed; a business data generation section that generates business data by processing the performance data into a structure used by a business application based on data to be the basic information in the master data; and a business data storage section that stores the business data generated by the business data generation section. The master data includes an attribute that represents start of an effective period of data to be the basic information and an attribute that represents end of the effective period.

A business management system of one aspect of the present invention includes: the performance data management device and a business application that uses performance data managed by the performance data management device.

### Advantageous Effects of Invention

According to at least one aspect of the present invention, it is possible to ensure consistency of related data even when a change occurs in content of performance data of a manufacturing site system.

Problems, configurations, and effects other than those described above will be made clear by the description of the following embodiments.

### BRIEF DESCRIPTION OF DRAWINGS

FIG. 1 is a view illustrating an example of a manufacturing site system.

FIG. 2 is a block diagram illustrating an overall configuration example of a business management system in which the business application according to a first embodiment of the present invention uses performance data of the manufacturing site system.

FIG. 3 is a block diagram illustrating a hardware configuration example of a computer included in each device constituting the manufacturing site system and the business management system.

FIG. 4 is a view illustrating a configuration example of performance data according to the first embodiment of the present invention.

FIG. 5 is a view illustrating a configuration example of master data according to the first embodiment of the present invention.

FIG. 6 is a flowchart illustrating an operation example of a performance data processing section according to the first embodiment of the present invention.

FIG. 7 is a flowchart illustrating an operation example of a master data processing section according to the first embodiment of the present invention.

FIG. 8 is a view illustrating a configuration example of a performance data storage section according to the first embodiment of the present invention.

FIG. 9 is a view illustrating a configuration example of a master data storage section according to the first embodiment of the present invention.

FIG. 10 is a flowchart illustrating an operation example of a business data generation section according to the first embodiment of the present invention.

FIG. 11 is a view illustrating a configuration example of each table of master data stored in the business data storage section according to the first embodiment of the present invention.

FIG. 12 is a view illustrating a configuration example of a table of performance data stored in the business data storage section according to the first embodiment of the present invention.

FIG. 13 is a block diagram illustrating a configuration example of a master data registration section according to the first embodiment of the present invention.

FIG. 14 is a flowchart illustrating a procedure example of master data registration processing by the master data registration section according to the first embodiment of the present invention.

FIG. 15 is a view illustrating an example of a screen (item addition screen) for registering item data according to the first embodiment of the present invention.

FIG. 16 is a view illustrating an example of an error screen output when an invalid value is set in input information according to the first embodiment of the present invention.

FIG. 17 is a flowchart illustrating a procedure example of master data update processing by the master data registration section according to the first embodiment of the present invention.

FIG. 18 is a view illustrating an example of a screen (item update screen) for updating item data according to the first embodiment of the present invention.

FIG. 19 is a view illustrating an example of a screen (bills of materials definition screen) for registering BOM management information according to the first embodiment of the present invention.

FIG. 20 is a view illustrating an example of a screen (bills of materials definition screen) after registering BOM management information according to the first embodiment of the present invention.

FIG. 21 is a view illustrating a change example of display content of a screen (bills of materials definition screen) after registering BOM management information due to a change in designated date and time according to the first embodiment of the present invention.

FIG. 22 is a view illustrating an example of hierarchical structure data of components registered for each effective period according to the first embodiment of the present invention.

FIG. 23 is a view illustrating an example of a screen (process addition screen) for registering process data according to the first embodiment of the present invention.

FIG. 24 is a view illustrating an example of a screen (process addition screen) for updating process data according to the first embodiment of the present invention.

FIG. 25 is a view illustrating an example of a screen (bills of materials definition screen) for registering a process branch according to the first embodiment of the present invention.

FIG. 26 is a view illustrating an example of a screen (bills of materials definition screen) after registering the process branch according to the first embodiment of the present invention.

FIG. 27 is a view illustrating a change example (bills of materials definition screen) of display content of a screen after registering a process branch due to a change in designated date and time according to the first embodiment of the present invention.

FIG. 28 is a view illustrating an example of screen display when the business application according to the first embodiment of the present invention acquires data from the performance data management device.

FIG. 29 is a view illustrating a configuration example of performance data classified into four elements of production according to a second embodiment of the present invention.

### DESCRIPTION OF EMBODIMENTS

In general, business is repeatedly practiced, business performance data increases (accumulates) every day. This business data is used in various business applications. Therefore, there is a high demand for a method of managing a large amount of business performance data and cooperating the performance data with the business applications. For performance data management at a manufacturing site, various methods have been established. However, a performance data management method having a method for ensuring consistency with respect to a change in the performance data being managed has not been established.

For example, when a name of specific data is changed, related data refers to data after the change. In this case, since past data registered before the name change refers to the data after the name change, data inconsistency occurs. At a manufacturing site, since it is necessary to trace a trail from past performance data, a mechanism for changing data while ensuring consistency of past data is necessary. Therefore, the inventors have invented a management method that enables cooperation between management of performance data and a business application and secures consistency of data.

### First Embodiment

Examples of embodiments for carrying out the present invention will be described below with reference to the accompanying drawings. In the present description and the accompanying drawings, constituent elements having substantially identical function or configuration are denoted by identical reference signs, and redundant description is omitted. As the first embodiment of the present invention, a case where the present invention is applied to a business management system in which performance data of a manufacturing site system is used by a business application will be described.

[Example of Work Site System]

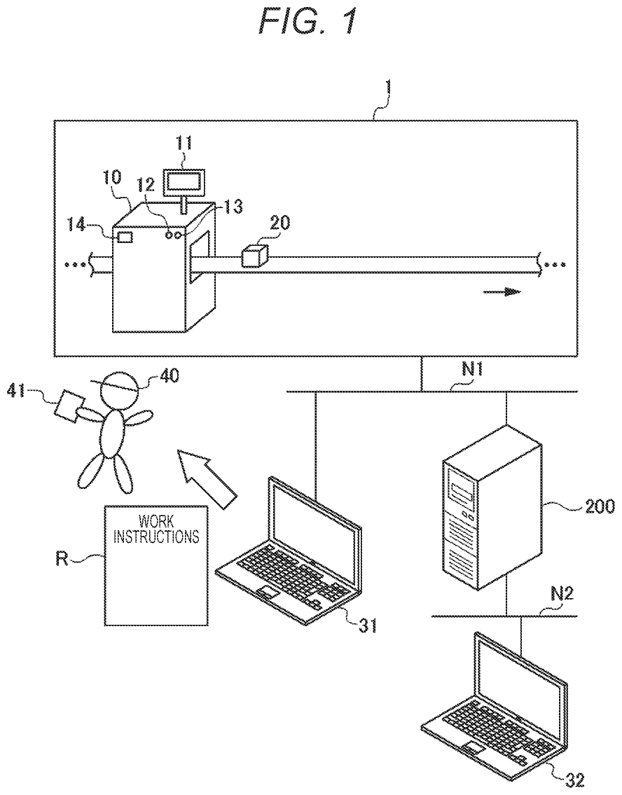

First, an example of a manufacturing site system that generates performance data will be described with reference to FIG. 1. FIG. 1 illustrates an example of a manufacturing site system. A manufacturing site system 1 (an example of a control system) illustrated in FIG. 1 includes a processing machine 10 that performs preset processing on a processing target object to produce a processed product 20, and a plurality of machines such as an assembly machine and an inspection machine that are not illustrated. The manufacturing site system 1 is connected with a controller not illustrated that controls the manufacturing site system 1 based on various state quantities, a production target, and the like acquired from the manufacturing site system 1. In the processing machine 10, a housing that protects the processing machine is provided with an operation panel 11, a processing start button 12, a processing end button 13, and a reader/writer device 14.

The manufacturing site system 1 is connected with a terminal device 31 and a performance data management device 200 via a field network N1. The performance data management device 200 is connected to a terminal device 32 via a control network N2. The field network N1 and the control network N2 are wired or wireless local area networks (LAN). This network configuration is an example, and for example, the controller may be connected between the manufacturing site system 1 and the field network N1.

A worker 40 sees work instructions R displayed on the terminal device 31 or work content described in the printed matter of the work instructions R to confirm that the processing work is instructed, and operates the processing machine 10. For example, before operating the processing machine 10, the worker 40 holds an employee card 41 made of an IC card over the reader/writer device 14 of the processing machine 10, and inputs worker information recorded on an IC chip of the employee card 41 to the processing machine 10. Due to this, worker information (for example, contact name) of the worker 40 who has operated the processing machine 10 is recorded in the processing machine 10, that is, the manufacturing site system 1.

Thereafter, when the worker 40 presses the processing start button 12 and the processing end button 13 based on the work instructions, the processing machine 10 executes processing start and processing end. The processing machine 10 (manufacturing site system 1) outputs information indicating operation performance to the performance data management device 200 as performance data. The processing machine 10 (manufacturing site system 1) creates performance data in a format that can be processed by the performance data management device 200.

Similarly, the worker 40 in charge of the work performs assembly work, inspection work, or other works based on the work instructions R. According to the work having been carried out, each performance data is sequentially captured and managed in the performance data management device 200. In the present embodiment, a series of works at a manufacturing site is referred to as “business”.

Note that the worker 40 may register the worker information of the worker 40 (and information on processing start by the worker 40) into the performance data management device 200 by operating the operation panel 11 or operating the terminal device 31. The processing machine 10 may execute processing start and processing end by the worker 40 inputting commands of processing start and processing end via the operation panel 11.

For example, an operation procedure may be set such that a processing start command to the processing machine 10 becomes possible by the operator 40 operating the operation panel 11 or the terminal device 31 to input worker information. In this case, the registration of the worker information (information on the processing start by the worker 40) and the processing start of the processing machine 10 may be registered in the performance data management device 200 at the same time.

The processing machine 10 may include a code reader, and the worker 40 may instruct processing start and processing end to the processing machine 10 by operating the code reader to read information of a code (barcode, two-dimensional code, and the like) for each work printed (displayed) on the work instructions R.

[Overall Configuration of Business Management System]

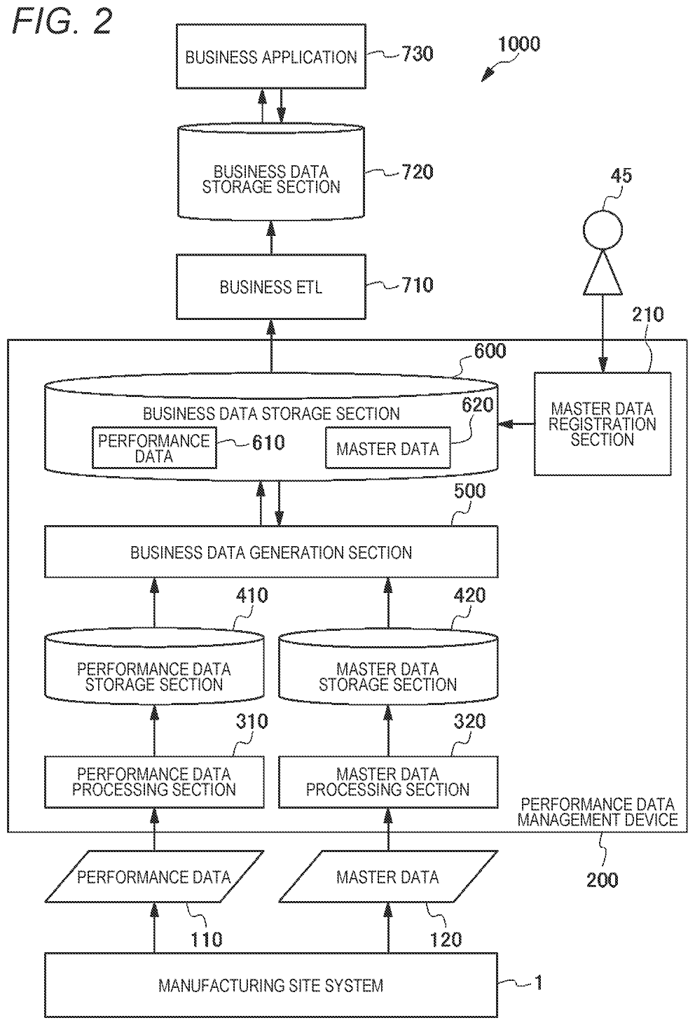

Next, an overall configuration example of the business management system will be described with reference to FIG. 2.

FIG. 2 is a block diagram illustrating an overall configuration example of a business management system 1000 in which the business application according to the first embodiment uses performance data of the manufacturing site system 1.

The business management system 1000 includes the performance data management device 200 that acquires and manages performance data 110 and master data 120 from the manufacturing site system 1, a business extract/transform/load (ETL) 710, a business data storage section 720, and a business application 730.

The manufacturing site system 1 generates and transmits, to the performance data management device 200, the performance data 110 including information indicating performance of the manufacturing site system 1. The performance of the manufacturing site system 1 is a result of operation, a produced product, a consumed substance, their amounts, and the like as a result of the dynamics and operation of the manufacturing site system 1.

(Performance Data Management Device)

The performance data management device 200 acquires and manages the performance data 110 generated by the manufacturing site system 1. The performance data management device 200 creates business data from the performance data 110 and provides the business data to the business application 730. The performance data management device 200 acquires and manages the master data 120 transmitted from the manufacturing site system 1.

This performance data management device 200 includes a performance data processing section 310, a performance data storage section 410, a master data processing section 320, a master data storage section 420, a business data generation section 500, a business data storage section 600, and a master data registration section 210.

The performance data processing section 310 performs processing of acquiring and recording, in the performance data storage section 410, the performance data 110 transmitted from the manufacturing site system 1. The performance data 110 is data in which details of events that have occurred with actual business are recorded. The performance data is sometimes referred to as transaction data.

The performance data storage section 410 is a nonvolatile or volatile storage section in which the performance data 110 is recorded by the performance data processing section 310.

The master data processing section 320 performs processing of acquiring and recording, in the master data storage section 420, the master data 120 transmitted from the manufacturing site system 1. The master data 120 is ledger data in which basic attribute information of items related to business is collected. In the present invention, transmission of the master data 120 by the manufacturing site system 1 is not essential.

The master data storage section 420 is a nonvolatile or volatile storage section in which the master data 120 is recorded by the master data processing section 320.

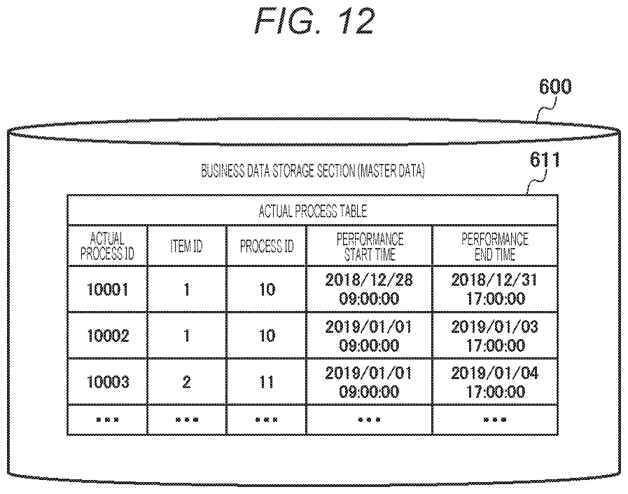

The business data generation section 500 acquires performance data recorded in the performance data storage section 410 and records the performance data into performance data 610 in the business data storage section 600. The business data generation section 500 updates the performance data 610 in the business data storage section 600 with the acquired performance data. The business data generation section 500 processes the acquired performance data into a structure (see an actual process table 611 in FIG. 12, for example) that can be used by the business application. The business data generation section 500 acquires master data recorded in the master data storage section 420, and records (adds) the master data into master data 620 in the business data storage section 600.

The business data storage section 600 is a nonvolatile or volatile storage section in which the performance data 610 and the master data 620 are recorded (accumulated) as data (business data) used by the business application. The business data storage section 600 records the master data 620 to be registered by the master data registration section 210. As the master data 620, data necessary for management of the performance data, such as an ID and a name of an item, and an ID and a name of a process, are managed.

The business data storage section 600 is also an example of a performance data storage section and a master data storage section. An area in the business data storage section 600 where the performance data 610 is recorded is sometimes referred to as “business data storage section 600 (performance data)”. An area in the business data storage section 600 where the master data 620 is recorded is sometimes referred to as “business data storage section 600 (master data)”.

On the basis of an instruction from a system manager 45, for example, the master data registration section 210 registers the master data 620 into the business data storage section 600 or updates the master data 620.

The business ETL 710 is a business data conversion processing section that generates business data based on the performance data 610 and the master data 620. The business ETL 710 extracts performance data corresponding to a designated item ID, process ID, and the like from the performance data 610 accumulated in the business data storage section 600, and performs processing of converting the performance data according to a purpose (business application 730). Then, the business ETL 710 stores the performance data subjected to the conversion processing, that is, the business data into the business data storage section 720. Thus, when registering or updating the performance data into the business data storage section 720, the business ETL 710 registers the transaction data by using information of the master data 620.

The business data storage section 720 is a nonvolatile or volatile storage section that accumulates business data extracted from the business data storage section 600 by the business ETL 710 and converted according to the purpose.

The business application 730 is an application used for managing, streamlining, and improving business. Cooperating with the performance data management device 200, the business application 730 outputs a result by using business data stored in the business data storage section 720. The user uses the business data in the performance data management device 200 through the output result of the business application 730.

Note that the business data generation section 500 and the business data storage section 600 may be configured to function of both the business ETL 710 and the business data storage section 720.

[Hardware Configuration of Each Device]

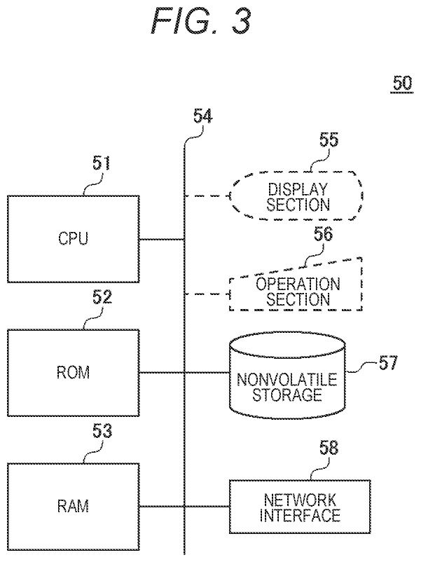

FIG. 3 is a block diagram illustrating a hardware configuration example of a computer included in each device constituting the manufacturing site system 1 and the business management system 1000. Each section in the device is selected according to the function and purpose of use of each device. Here, a hardware configuration example of the above-described performance data management device 200 will be described.

A computer 50 of the performance data management device 200 includes a central processing unit (CPU) 51, a read only memory (ROM) 52, a random access memory (RAM) 53, a nonvolatile storage 57, and a communication interface 58. Sections in the performance data management device 200 are connected to be able to transmit and receive data to and from one another via a system bus 54.

The CPU 51, the ROM 52, and the RAM 53 constitute a control section. This control section controls the operation of the entire performance data management device 200 or each section. The CPU 51 reads, from the ROM 52, and executes a program code of software for implementing each function according to the present embodiment, and performs control of each section and various arithmetic operations. Instead of the CPU 51, another arithmetic processing unit such as a micro processing unit (MPU) may be used.

The ROM 52 is used as an example of a nonvolatile memory (recording medium), and the ROM 52 stores a program, data, and the like necessary for the CPU 51 to operate. The RAM 53 is used as an example of a volatile memory, and the RAM 53 temporarily stores a variable, a parameter, and the like generated in the middle of arithmetic processing by the CPU 51.

The nonvolatile storage 57 is an example of a recording medium, and can store a program such as an operating system (OS), a parameter used when the program is executed, data obtained by executing the program, and the like. For example, the performance data storage section 410, the master data storage section 420, and the business data storage section 600 in FIG. 2 are configured using the nonvolatile storage 57.

A program executed by the CPU 51 may be stored in the nonvolatile storage 57. As the nonvolatile storage 57, a semiconductor memory, a hard disk, a solid state drive (SSD), a recording medium using magnetism or light, or the like is used. Note that the program may be provided via a wired or wireless transmission medium such as a local area network (LAN), the Internet, or digital satellite broadcasting.

As the communication interface 58, for example, a network interface card (NIC), a modem, or the like is used, and is configured to be able to transmit and receive various data to and from an external device via a network such as a LAN to which a terminal is connected, a dedicated line, or the like.

Note that the computer 50 may be provided with a display section 55 such as a liquid crystal display and an operation section 56 such as a mouse and a keyboard. The display section 55 displays a GUI screen, a result of processing performed by the CPU 51, and the like, and the operation section 56 generates and supplies, to the CPU 51, an input signal according to a user's operation. For example, the worker 40, the system manager 45, and the like can check the screen displayed on the display section 55 and perform necessary editing through the operation section 56.

The hardware configuration of the terminal devices 31 and 32 illustrated in FIG. 1 can also be configured similarly to the performance data management device 200. A device mounted with at least the business ETL 710 and/or the business application 730 can also have the hardware configuration illustrated in FIG. 3.

(Configuration of Performance Data)

FIG. 4 illustrates a configuration example of the performance data 110 transmitted by the manufacturing site system 1.

As attributes (data items), the performance data 110 has, for example, an item ID 111, a process ID 112, a product ID 113, a data type 114, an event type 115, and an event occurrence time 116.

The item ID 111 is information for uniquely identifying the item (information for uniquely identifying the type of the product).

The process ID 112 is information for uniquely identifying the process.

The product ID 113 is information for uniquely identifying the product of the corresponding item. These IDs are information for citing a name registered in the master data 620.

The data type 114 indicates the type (an event related to a machine, an event related to a man, and the like) of data included in the present data.

The event type 115 indicates the event that has occurred. The events include start, end, middle, plan start, and plan end.

The event occurrence time 116 indicates the time at which an event occurs (start time, end time, and the like of a machine).

When these data are transmitted in a file format, the data type 114 or the like may be transmitted as a file name.

(Configuration of Master Data)

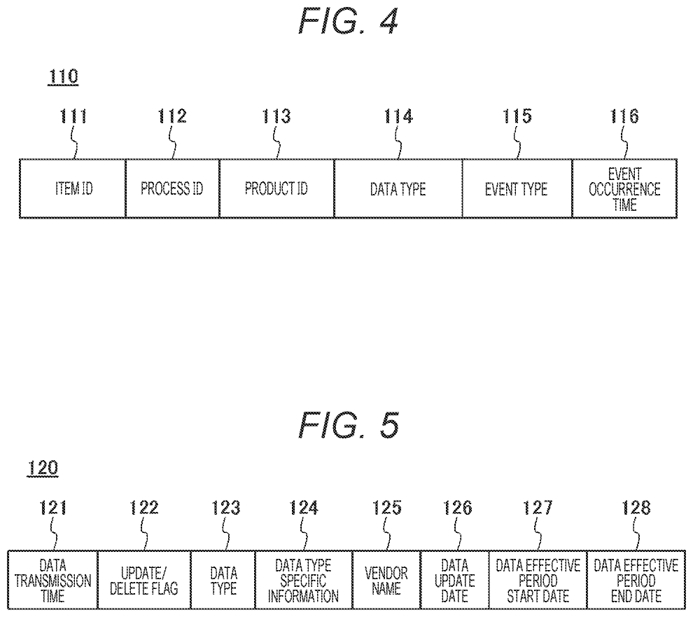

FIG. 5 illustrates a configuration example of the master data 120 transmitted by the manufacturing site system 1.

As attributes (data items), the master data 120 has, for example, a data transmission time 121, an update/delete flag 122, a data type 123, data type specific information 124, a vendor name 125, a data update date 126, a data effective period start date 127, and a data effective period end date 128.

The data transmission time 121 indicates the time at which the present data is transmitted.

The update/delete flag 122 is a flag indicating the type of registration, update, or deletion. Registration (addition), update, and deletion of the present data to the master data 620 are determined on the basis of the information of the update/delete flag 122.

The data type 123 indicates the type of the present data. The types of data include an item master and a process master.

The data type specific information 124 is specific information for each master in the data type 123. An item name in the item master is an example thereof.

The vendor name 125 indicates the name of the vendor. For example, the vendor is a company that manufactures (or delivers) a product, a component, a material, or the like, a company that executes a process, and the like.

The data update date 126 indicates the date when the present data is updated in a case where the update/delete flag 122 indicates update.

The data effective period start date 127 indicates the start date of the effective period of the present data.

The data effective period end date 128 indicates the end date of the effective period of the present data.

In a case where these data are transmitted in a file format, the data type 123 or the like may be transmitted as a file name.

[Operation of Performance Data Processing Section]

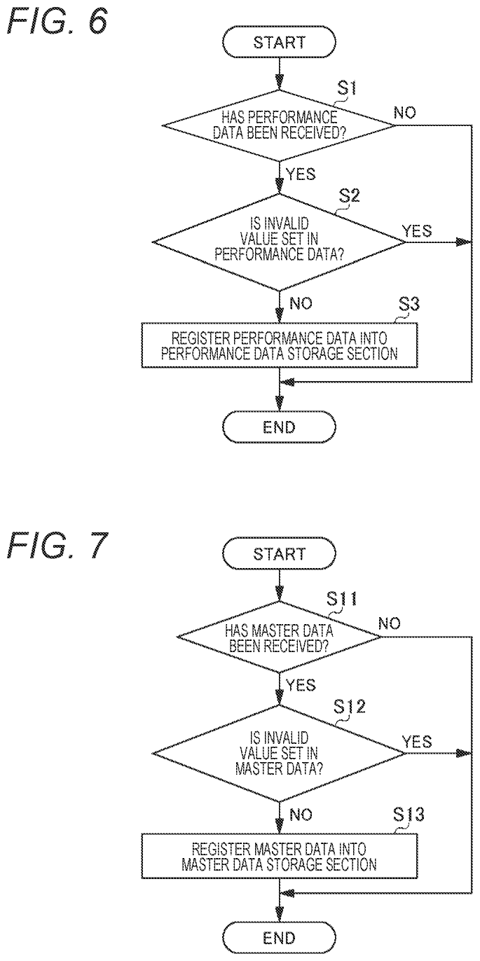

Next, the operation of the performance data processing section 310 will be described with reference to FIG. 6.

FIG. 6 is a flowchart illustrating an operation example of the performance data processing section 310.

First, the performance data processing section 310 determines whether the performance data 110 has been received from the manufacturing site system 1 (S1), and ends the processing of the present flowchart if the performance data 110 has not been received (NO in S1).

Next, if the performance data 110 has been received (YES in S1), the performance data processing section 310 determines whether an invalid value has been set in the performance data 110 (S2), and ends the processing of the present flowchart if an invalid value has been set (YES in S2). For example, in a case where the start time and the end time of the performance data are reversed in time series, it is regarded as an invalid value. In a case where the event occurrence time is ahead of the current time point, it corresponds to an invalid value.

Next, if an invalid value has not been set (NO in S2), the performance data processing section 310 registers the performance data 110 into the performance data storage section 410 (S3), and ends the processing of the present flowchart.

[Master Data Processing Section]

Next, the operation of the master data processing section 320 will be described with reference to FIG. 7.

FIG. 7 is a flowchart illustrating an operation example of the master data processing section 320.

First, the master data processing section 320 determines whether the master data 120 has been received from the manufacturing site system 1 (S11), and ends the processing of the present flowchart if the master data 120 has not been received (NO in S11).

Next, if the master data 120 has been received (YES in S11), the master data processing section 320 determines whether an invalid value has been set in the master data 120 (S12), and ends the processing of the present flowchart if an invalid value has been set (YES in S12). For example, in a case where the event occurrence time is ahead of the current time point, it corresponds to an invalid value.

Next, if an invalid value has not been set (NO in S12), the master data processing section 320 registers the master data 120 into the master data storage section 420 (S13), and ends the processing of the present flowchart.

[Configuration of Performance Data Storage Section]

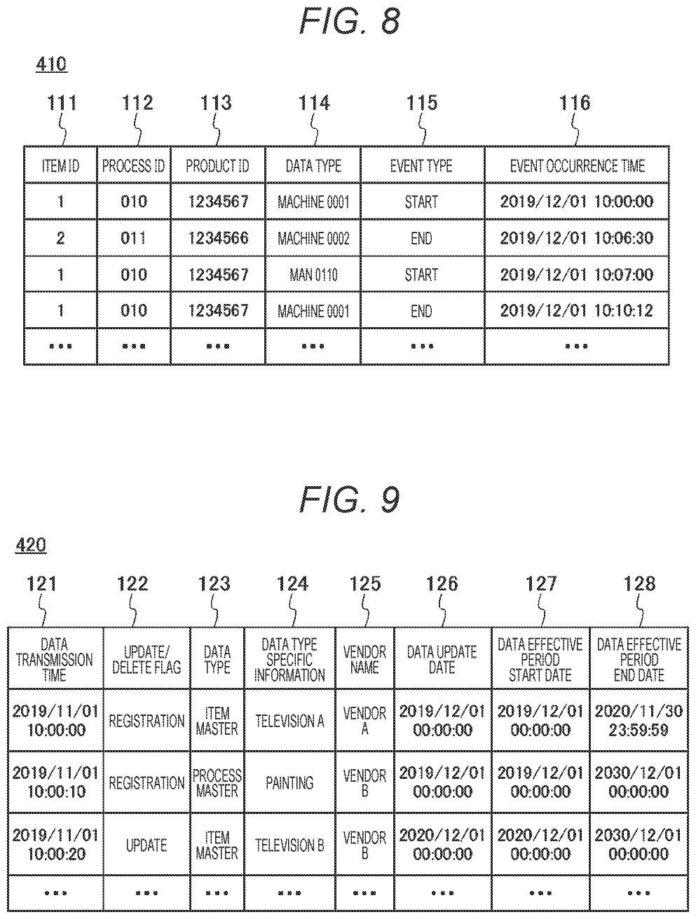

FIG. 8 illustrates a configuration example of the performance data storage section 410.

The performance data storage section 410 has a field of the same attribute (data item) as that of the performance data 110 (FIG. 4). That is, the performance data storage section 410 includes fields of the item ID 111, the process ID 112, the product ID 113, the data type 114, the event type 115, and the event occurrence time 116.

For example, in FIG. 8, each piece of information of the item ID 111 “1”, the process ID 112 “010”, the product ID 113 “1234567”, the data type 114 “MACHINE 001”, the event type 115 “START”, and the event occurrence time 116 “2019/12/01 10:00:00” is registered in the first record of the performance data storage section 410.

[Configuration of Master Data Storage Section]

FIG. 9 illustrates a configuration example of the master data storage section 420.

The master data storage section 420 has a field of the same attribute (data item) as that of the master data 120 (FIG. 4). That is, the master data storage section 420 has each field of the data transmission time 121, the update/delete flag 122, the data type 123, the data type specific information 124, the vendor name 125, the data update date 126, the data effective period start date 127, and the data effective period end date 128. In each data (record), the start date and the end date of the data effective period are set.

For example, in FIG. 9, each piece of information of the data transmission time 121 “2019/11/01 10:00:00”, the update/delete flag 122 “REGISTRATION”, the data type 123 “ITEM MASTER”, the data type specific information 124 “TELEVISION A”, the vendor name 125 “VENDOR A”, the data update date 126 “2019/12/01 00:00:00”, the data effective period start date 127 “2019/11/01 10:00:00”, and the data effective period end date 128 “2020/11/30 23:59:59” is registered in the first record of the master data storage section 420.

Each data in the performance data storage section 410 and the master data storage section 420 can be configured using comma-separated values (CSV) as an example.

[Operation of Business Data Generation Section]

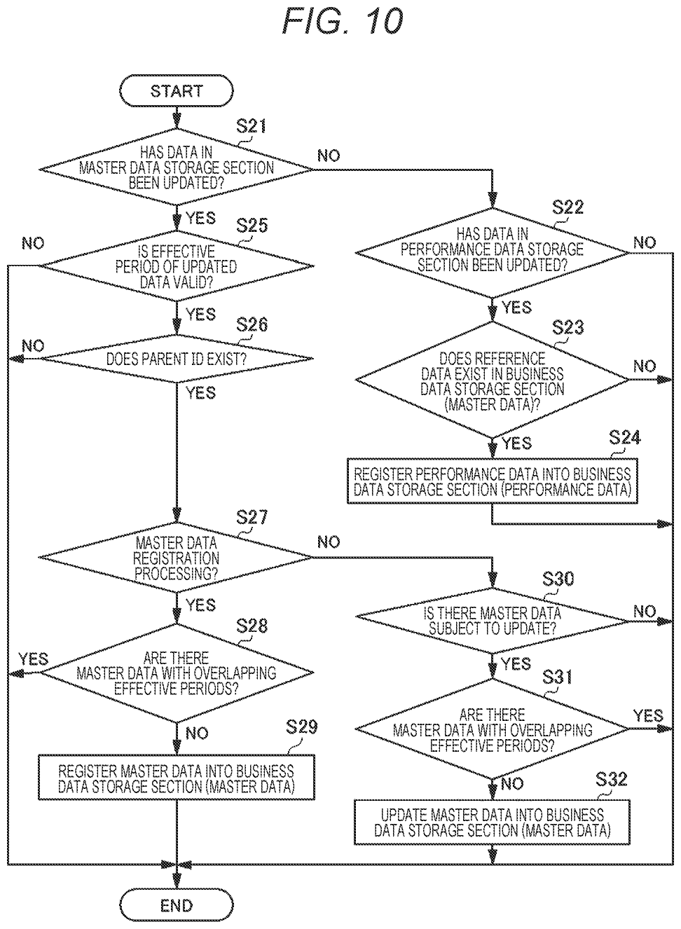

Next, the operation of the business data generation section 500 will be described with reference to FIG. 10.

FIG. 10 is a flowchart illustrating an operation example of the business data generation section 500. The business data generation section 500 executes the processing of the present flowchart at a predetermined cycle.

First, the business data generation section 500 determines whether data stored in the master data storage section 420 has been updated (registration and change of data). For example, whether the data in the master data storage section 420 has been updated can be determined by detecting an increase in recorded data (record), an increase in file size, or the like. Then, if the data in the master data storage section 420 has not been updated (NO in S21), the business data generation section 500 moves to step S22.

Next, the business data generation section 500 determines whether data stored in the performance data storage section 410 has been updated (registration and change of data) (S22). If the data in the performance data storage section 410 has been updated (YES in S22), the business data generation section 500 determines whether reference data (data item) of the corresponding performance data exists in the business data storage section 600 (master data) (S23). Here, if the reference data (data item) exists in the business data storage section 600 (master data) (YES in S23), the business data generation section 500 registers the corresponding performance data into the business data storage section (performance data) (S24). After the processing of step S24, the business data generation section 500 ends the processing of the present flowchart.

If the data in the performance data storage section 410 has not been updated (NO in S22) or if the reference data (data item) of the corresponding performance data does not exist in the business data storage section 600 (master data) (NO in S23), the business data generation section 500 ends the processing of the present flowchart. Unless the reference data exists in the business data storage section 600 (master data), the performance data subject to update cannot be managed as business data.

Next, if the data in the master data storage section 420 has been updated (YES in S21), the business data generation section 500 determines whether the effective period of the updated data is valid (S25). For example, in a case where the effective period start date and the effective period end date are reversed in time series, the effective period is not valid. If the effective period of the updated data is not valid (NO in S25), the business data generation section 500 ends the processing of the present flowchart.

Next, if the effective period is valid (YES in S25), the business data generation section 500 determines whether a parent ID exists in the data item of the updated data (S26). The parent ID has a parent-child relationship between data in a BOM master table, a sequence master table, and the like. Then, the business data generation section 500 moves to step S27 if the parent ID exists (YES in S26), and ends the processing of the present flowchart if the parent ID does not exist (NO in S26).

Next, the business data generation section 500 confirms the update/delete flag 122 (see FIG. 9) of the corresponding master data and determines whether master data registration processing is necessary (S27). If the registration flag is on in the update/delete flag 122, it is necessary to register the corresponding master data into the business data storage section 600. Here, the business data generation section 500 moves to step S28 if performing the master data registration processing (YES in S27), and moves to step S30 if not performing the master data registration processing (NO in S27).

Next, the business data generation section 500 determines whether master data having an effective period overlapping with that of the updated master data in the master data storage section 420 exists in the business data storage section 600 (master data) (S28). Next, if the effective period of the master data does not overlap (NO in S28), the business data generation section 500 registers the updated master data into the business data storage section 600 (master data) (S29). After the processing of step S29 or if the effective period of the master data overlaps (YES in S28), the business data generation section 500 ends the processing of the present flowchart.

On the other hand, if not performing the master data registration processing (NO in S27), the business data generation section 500 confirms the update/delete flag 122 and determines whether the master data subject to update exists (the update flag is on) (S30). If the master data subject to update exists (YES in S30), the business data generation section 500 determines whether master data having an effective period overlapping with that of the updated master data in the master data storage section 420 exists in the business data storage section 600 (master data) (S31). Next, if master data having an overlapping effective period does not exist (NO in S31), the business data generation section 500 records (updates) the updated master data into the business data storage section 600 (master data) (S32).

After the processing of step S31, the processing of the present flowchart is ended. If the master data subject to update does not exist (NO in S30) or if master data having an overlapping effective period exists (YES in S31), the business data generation section 500 ends the processing of the present flowchart.

[Table Configuration of Master Data]

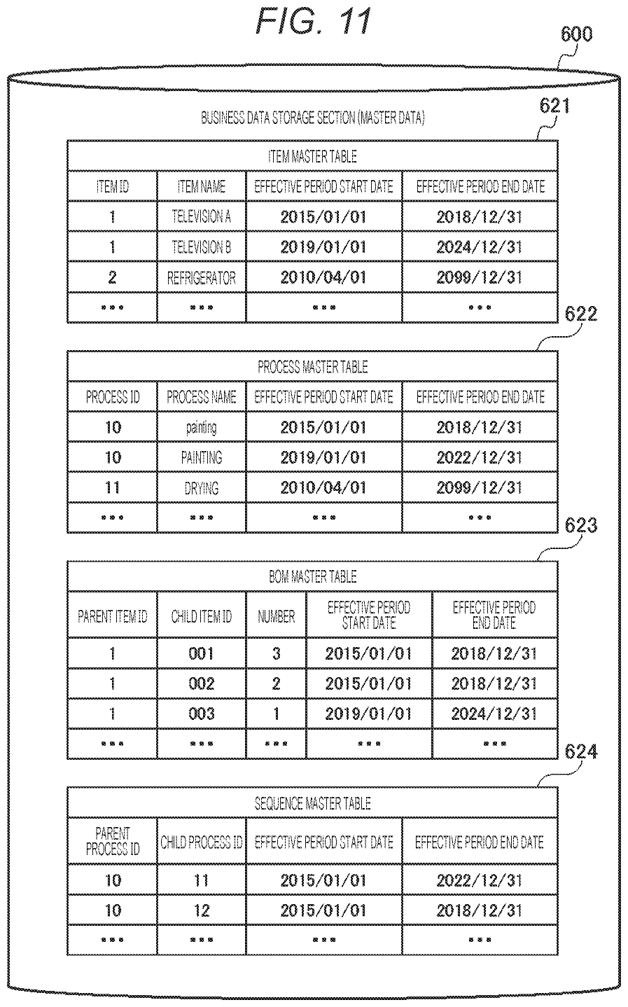

FIG. 11 illustrates a configuration example of each table of the master data 620 stored in the business data storage section 600.

As examples of the master data 620, an item master table 621, a process master table 622, a BOM master table 623, and a sequence master table 624 are presented in the business data storage section 600.

(Item Master Table)

The item master table 621 is a table indicating a correspondence relationship between the item ID and the item name, and has “ITEM ID”, “ITEM NAME”, “EFFECTIVE PERIOD START DATE”, and “EFFECTIVE PERIOD END DATE” as fields.

The item ID is the same as the item ID 111 (FIGS. 4 and 8), and is information for uniquely identifying the item.

The item name indicates the name of the item specified by the item ID.

The effective period start date indicates the start date of the effective period of the present data (record).

The effective period end date indicates the end date of the effective period of the present data (record).

In the example of FIG. 11, “TELEVISION A” and “TELEVISION B” are registered as the item name for the item ID “1”. As illustrated in FIG. 9, the television A is manufactured by the vendor A, and the television B is manufactured by a vendor B. After the effective period of the data for the television A ends, the effective period of the data for the television B subsequently starts.

(Process Master Table)

The process master table 622 is a table indicating a correspondence relationship between the process ID and the process name, and has “PROCESS ID”, “PROCESS NAME”, “EFFECTIVE PERIOD START DATE”, and “EFFECTIVE PERIOD END DATE” as fields.

The process ID is the same as the process ID 112 (FIGS. 4 and 8), and is information for uniquely identifying the process.

The process name indicates the name of the process specified by the process ID.

The effective period start date indicates the start date of the effective period of the present data (record).

The effective period end date indicates the end date of the effective period of the present data (record).

In the example of FIG. 11, “painting” and “PAINTING” are registered as the process name for the process ID “10”. This is because the manager 45 has input one process name in lower case and the other process name in upper case when registering the process name. For example, also in a case of using other scripts or other symbols, there is a possible difference in half-width/full-width, upper-case/lower-case, and the like. After the effective period of the data for “painting” ends, the effective period of the data for “PAINTING” subsequently starts.

(BOM Master Table)

The BOM master table 623 is a table indicating a correspondence relationship among the parent item ID, the child item ID, and the number, and has “PARENT ITEM ID”, “CHILD ITEM ID”, “NUMBER”, “EFFECTIVE PERIOD START DATE”, and “EFFECTIVE PERIOD END DATE” as fields.

The parent item ID indicates a parent item among items in a parent-child relationship, and corresponds to the item ID of the item master table.

The child item ID indicates a child item among items in the parent-child relationship.

The number indicates the quantity of child items.

The effective period start date indicates the start date of the effective period of the present data (record).

The effective period end date indicates the end date of the effective period of the present data (record).

(Sequence Master Table)

The sequence master table 624 is a table indicating a correspondence relationship between the parent process ID and the child process ID, and has “PARENT PROCESS ID”, “CHILD PROCESS ID”, “EFFECTIVE PERIOD START DATE”, and “EFFECTIVE PERIOD END DATE” as fields.

The parent process ID indicates a parent process (upstream process) among processes in a parent-child relationship, and corresponds to the process ID in the process master table.

The child process ID indicates a child process among processes in the parent-child relationship.

The effective period start date indicates the start date of the effective period of the present data (record).

The effective period end date indicates the end date of the effective period of the present data (record).

In the master table described above, the effective period sometimes changes when the data is changed. For example, in a case where the item name is changed in the item master table 621, the effective period is changed while the item ID remains the same, and the item name after the change is registered. Therefore, consistency of related data is ensured by the attribute of this effective period even if the content of the performance data is changed.

[Table Configuration of Performance Data (Actual Process Table)]

FIG. 12 illustrates a configuration example of the table of the performance data 610 stored in the business data storage section 600.

In the business data storage section 600, the actual process table 611 is illustrated as an example of the performance data 610. The actual process table 611 includes “ACTUAL PROCESS ID”, “ITEM ID”, “PROCESS ID”, “PERFORMANCE START TIME”, and “PERFORMANCE END TIME”.

The actual process ID is identification information for process management, and IDs are given in time series, for example. The item ID is the same as the item ID 111 (FIGS. 4 and 8), and is information for uniquely identifying the item.

The process ID is the same as the process ID 112 (FIGS. 4 and 8), and is information for uniquely identifying the process.

The performance start time is a time indicated by the event occurrence time 116 when the event type 115 (FIGS. 4 and 8) is “START”.

The performance end time is a time indicated by the event occurrence time 116 when the event type 115 (FIGS. 4 and 8) is “END”.

As described above, the business data storage section 600 manages the master data 620 by the effective period. Therefore, the process name and the item name to be acquired from the master data 620 by the business data generation section 500 vary depending on the performance start time and the performance end time of the process.

[Master Data Registration Section]

Next, the master data registration section 210 will be described in detail.

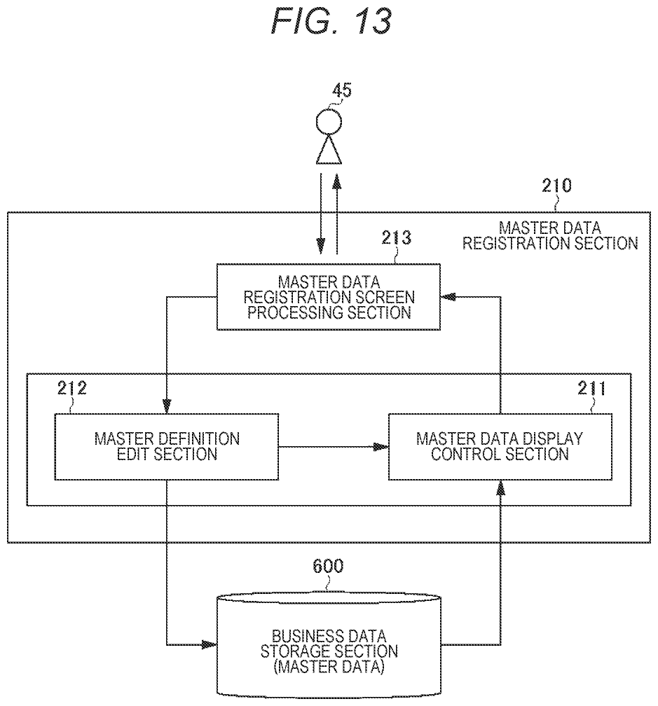

FIG. 13 is a block diagram illustrating a configuration example of the master data registration section 210. FIG. 13 will be described assuming that the performance data management device 200 includes the display section 55 and the operation section 56.

The master data registration section 210 includes a master data display control section 211, a master definition edit section 212, and a master data registration screen processing section 213. The master data display control section 211 and the master definition edit section 212 correspond to a server (application software). The master data registration screen processing section 213 corresponds to a browser (application software).

The master data display control section 211 reads the master data 620 from the business data storage section 600 (master data), and outputs a file of the master data 620 to the master data registration screen processing section 213 together with a file such as a registration screen or an update screen.

On the basis of the master data 620 input from the master data display control section 211 and the files of various screens, the master data registration screen processing section 213 constitutes the various screens and displays the master data on the display section 55. The master data registration screen processing section 213 outputs, to the master definition edit section 212, an editing instruction for the master data 620 performed through the operation section 56 by the manager 45 or the like who saw the various screens.

The master definition edit section 212 edits and stores, into the business data storage section 600 (master data), the master data 620 on the basis of the editing instruction input from the master data registration screen processing section 213.

[Master Data Registration Processing]

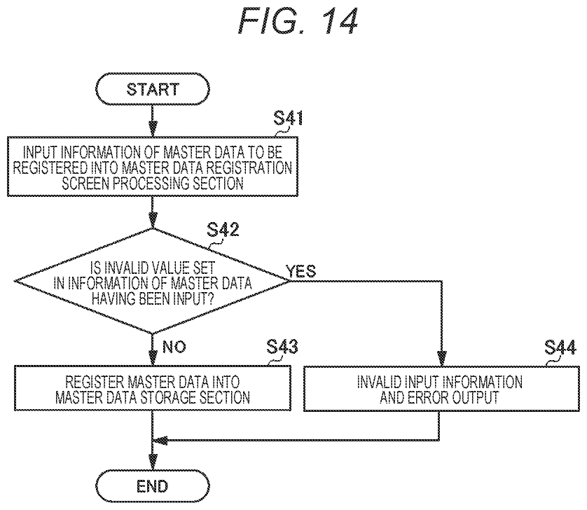

Next, the master data registration processing will be described with reference to FIG. 14.

FIG. 14 is a flowchart illustrating a procedure example of the master data registration processing by the master data registration section 210.

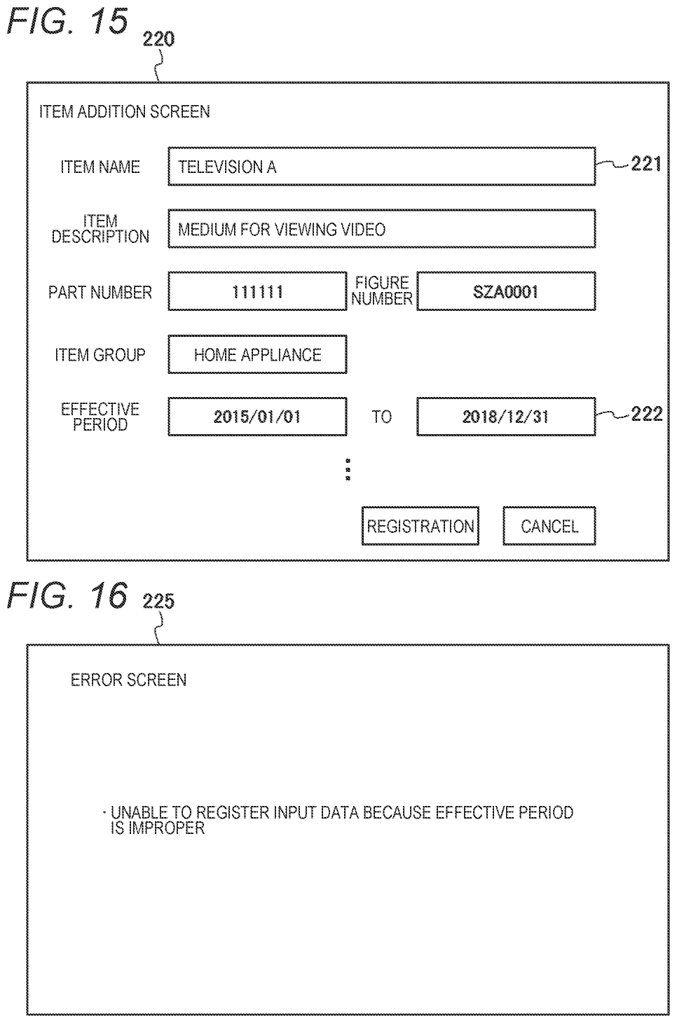

First, when the manager 45 selects a menu for registering (adding) master data from a menu screen (not illustrated) with the operation section 56, the master data registration section 210 receives an instruction of this selection. The master data registration screen processing section 213 displays, on the display section 55, a screen for registering (adding) the master data (for example, an item addition screen 220 illustrated in FIG. 15).

Then, when the manager 45 inputs, on the item addition screen 220, the information of the master data desired to register by the operation section 56, the information of the master data to be registered is input to the master data registration screen processing section 213 (S41). Thereafter, the master data registration screen processing section 213 receives a registration instruction by pressing a registration button (see FIG. 15) and instructs the master definition edit section 212 for registration processing. Next, the master definition edit section 212 determines whether an invalid value has been set in the input master data information (S42). Here, if determining that an invalid value has not been set in the input information (NO in S42), the master definition edit section 212 stores the input master data information (item data) into the master data 620 in the business data storage section 600 (S43).

In the present embodiment, when the master data is registered using the item addition screen 220, the master definition edit section 212 automatically gives and registers, into the master data 620, an item ID on the basis of the item name and/or item description. However, an item ID field may be provided so as to allow the manager 45 to directly input the item ID with the operation section 56. Note that the initial value of the version of the newly registered master data is “1”. The version is information for distinguishing between new and old master data, and in the present embodiment, the larger the value is, the newer the master data is.

On the other hand, if determining that an invalid value has been set in the input information (YES in S42), the master definition edit section 212 invalidates the input information and notifies the master data display control section 211 of an error. Upon receiving the error notification, the master data display control section 211 outputs an error screen 225 (see FIG. 16) described later to the display section 55 (S44). After the processing of step S43 or S44, the processing of the present flowchart is ended.

[Item Addition Screen]

Next, a screen for registering item data (item addition screen) will be described with reference to FIG. 15.

FIG. 15 illustrates an example of a screen for registering item data (the item addition screen 220).

The item addition screen 220 includes an item name field 221 and an effective period field 222. In addition, the item addition screen 220 includes at least an item description field, a part number field, a figure number field, an item group field, a registration button, and a cancel button. A feature of the item addition screen 220 is to include the effective period field 222. A well-known technique can be used for other configurations of the item addition screen 220.

The item name field 221 is a field for inputting the name of an item to be added.

The effective period field 222 is a field for inputting the effective period of the master data (record) registered on the item addition screen 220.

The item description field is a field for inputting the description of an item (product) indicated by an item name. The part number field is a field for inputting a number (a numeral or a symbol such as Roman alphabet) for identifying the type of the item (product) indicated by the item name.

The figure number is a field for inputting the number of a design drawing (mostly CAD data in general) of the item to be specified by the part number.

The item group is a field for inputting a group into which the item (product) indicated by the item name is classified.

The registration button is a button for registering the input information into the master data 620.

The cancel button is a button for canceling registration of the input information into the master data 620.

FIG. 16 illustrates an example of an error screen to be output when an invalid value is set in the input information. As explained in step S44 of FIG. 14, the master definition edit section 212 outputs the error screen 225 when an invalid value is set in the input information. For example, in a case where the effective period start date and the effective period end date in the effective period field 222 are reversed in time series, an error occurs. At this time, a message “UNABLE TO REGISTER INPUT DATA BECAUSE EFFECTIVE PERIOD IS IMPROPER” is displayed on the error screen 225.

[Master Data Update Processing]

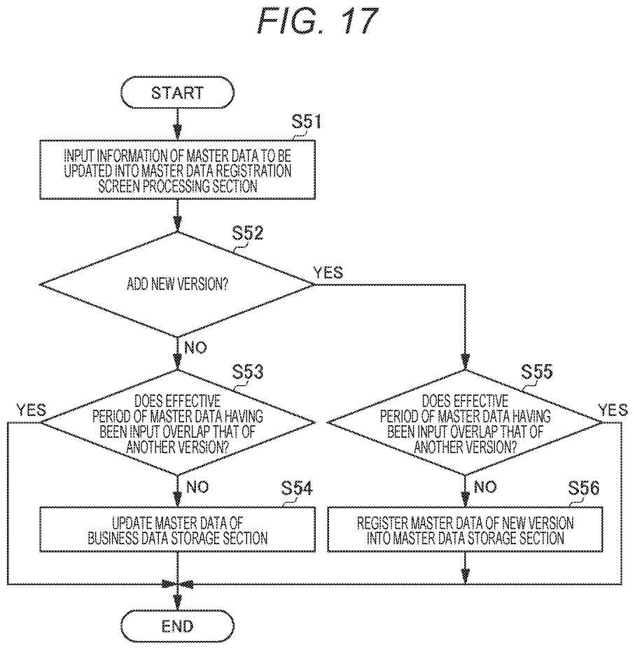

Next, the master data update processing will be described with reference to FIG. 17.

FIG. 17 is a flowchart illustrating a procedure example of the master data update processing by the master data registration section 210.

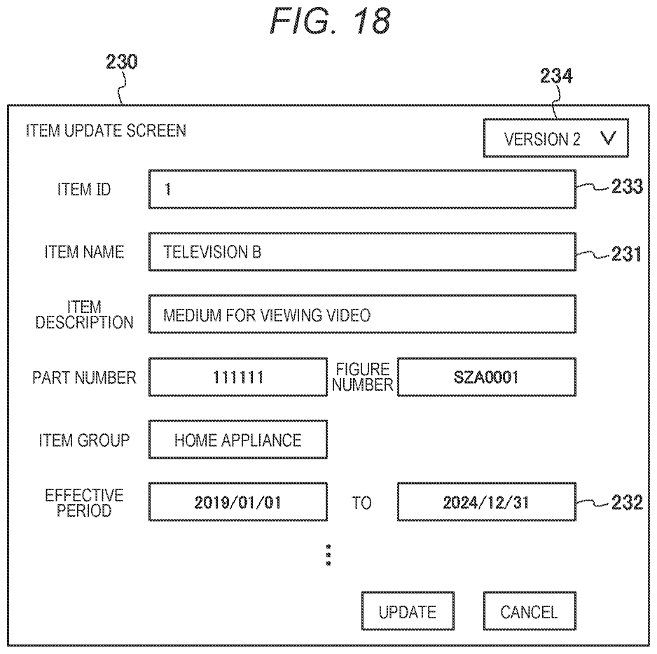

First, when the manager 45 selects a menu for updating (changing) master data from a menu screen (not illustrated) with the operation section 56, the master data registration section 210 receives an instruction of this selection. The master data registration screen processing section 213 displays, on the display section 55, a screen for updating (changing) the master data. When the manager 45 designates master data desired to update by the operation section 56, a screen (for example, an item update screen 230 illustrated in FIG. 18) for updating the designated master data is displayed on the display section 55.

Then, when the manager 45 inputs, on the item update screen 230, the information of the master data desired to update by the operation section 56, the information of the master data to be updated is input to the master data registration screen processing section 213 (S51). Thereafter, the master data registration screen processing section 213 receives an update instruction by pressing an update button (see FIG. 18) and instructs the master definition edit section 212 for update processing.

Next, the master definition edit section 212 determines whether addition of master data of a new version has been instructed (S52). Here, if addition of master data of the new version has not been instructed (NO in S52), the master definition edit section 212 moves to step S53. Then, the master definition edit section 212 determines whether the effective period of the master data (designated record) to which update information is input overlaps the effective period of master data (another record) of another version (S53). The version of master data will be described in detail with reference to FIG. 18.

Next, if the effective period of the master data to which update information is input overlaps the effective period of master data of another version (YES in S53), the master definition edit section 212 invalidates the input information and ends the processing of the present flowchart. Note that, in a case where there is only one version, determination is not performed regarding overlap of the effective period. However, similarly to step S42, it is determined whether or not an invalid value has been set in the input information. If an invalid value has been set in the input information, it is desirable to invalidate the input information and output an error. Also if there is an overlap in the effective period, it is preferable to output an error.

Next, if the effective period of the master data to which update information is input does not overlap the effective period of master data of another version (NO in S53), the master definition edit section 212 updates the master data 620 in the business data storage section 600 (S54).

On the other hand, if addition of master data of the new version has been instructed (YES in S52), the master definition edit section 212 moves to step S55. Then, the master definition edit section 212 determines whether the effective period of the master data (new record) of the new version overlaps the effective period of master data (another record) of an existing version (S55).

Next, if the effective period of the master data of the new version overlaps the effective period of the master data of an existing version (YES in S55), the master definition edit section 212 invalidates the input information and ends the processing of the present flowchart.

Next, if the effective period of the master data of the new version does not overlap the effective period of the master data of an existing version (NO in S55), the master definition edit section 212 stores information of the master data of the new version into the master data 620 in the business data storage section 600 (S56). After the processing of step S54 or S56, the processing of the present flowchart is ended.

[Item Update Screen]

Next, a screen (item update screen) for updating item data will be described with reference to FIG. 18.

FIG. 18 illustrates an example of a screen (item update screen 230) for updating item data.

The item update screen 230 includes at least an item ID field 233 and a version field 234 in addition to the configuration of the item addition screen 220. The item update screen 230 includes an update button instead of a registration button. A feature of the item update screen 230 is to include an effective period field 232 and the version field 234.

An item name field 231 is the same as the item name field 221.

The effective period field 232 is a field for inputting the effective period of the master data (record) updated on the item update screen 230.

The item ID field 233 is a field for inputting information corresponding to the item ID field of the item master table 621 illustrated in FIG. 11. In the item master table 621, the item ID “1” indicates “TELEVISION”. In the present embodiment, the item addition screen 220 does not display the item ID, but the item update screen 230 displays the item ID.

The version field 234 is a field for inputting the version of the present data (record). It is possible to increase the version of data by operating the version field 234. As the version field 234, for example, a graphical user interface (GUI) such as a pull-down menu or a list box can be used.

In the item update screen 230 of FIG. 18, “VERSION 2” is displayed in the version field 234. When the version of the designated master table is changed from “1” to “2”, the master table of the version 2 is newly created while leaving the master table of the old version 1. On the item update screen 230, the item name is changed to “TELEVISION B” with respect to the master table (version 1) registered on the item addition screen 220, and the effective period is set to “2019/01/01 TO 2024/12/31” in order to avoid overlap with the version 1. Then, by selecting the version 2 in the version field 234 and pressing the update button, the master table of the version 2 is created with this content.

[Bills of Materials Definition Screen (Item) Before Registration]

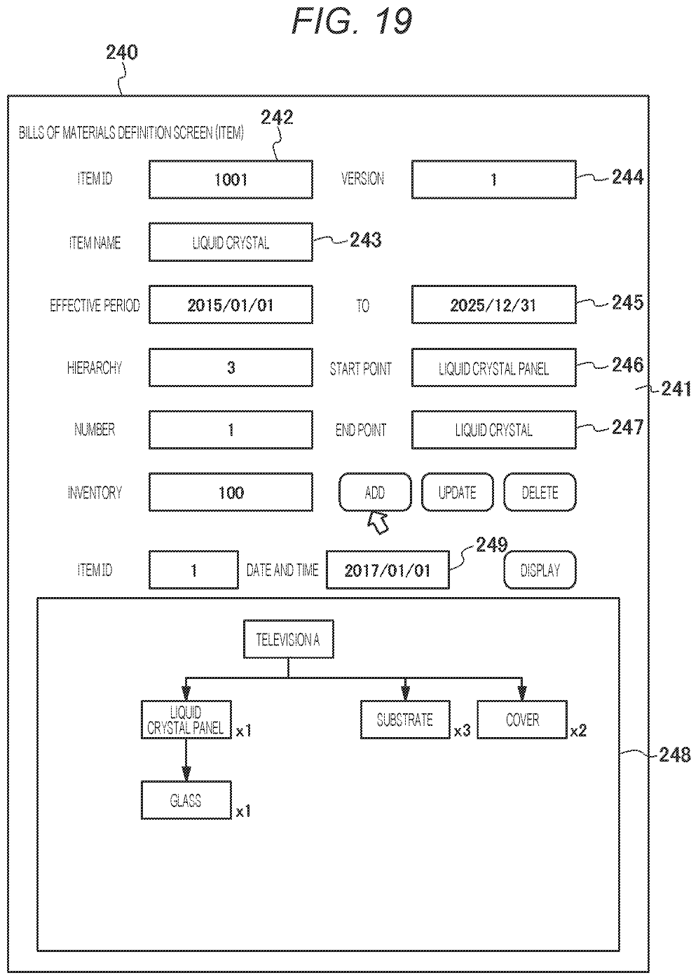

Next, a screen (bills of materials definition screen) for registering BOM management information will be described with reference to FIG. 19. In business management, a parts list is also referred to as bills of materials (BOM).

FIG. 19 illustrates an example of a screen (bills of materials definition screen 240) for registering BOM management information.

The bills of materials definition screen 240 has a BOM management information area 241 in the upper part of the screen and a component hierarchical structure area 248 indicating components constituting an item (product) in the lower part of the screen.

The BOM management information area 241 is an area for displaying information for managing components and materials necessary for assembly of an item (product).

The component hierarchical structure area 248 is an area for displaying a hierarchical structure of components.

The BOM management information area 241 includes an item ID field 242, an item name field 243, a version field 244, an effective period field 245, a parent-child item start point field 246 (parent item), and a parent-child item end point field 247 (child item). In addition, the BOM management information area 241 includes a hierarchy field, a number field, an inventory field, an add button, an update button, and a delete button.

The item ID field 242 is a field into which information of “PARENT ITEM ID+CHILD ITEM ID” of the BOM master table 623 illustrated in FIG. 11 is input.

The item name field 243 is a field for inputting the name of an item (component) subjected to definition.

The version field 244 is a field for inputting the version of the present data (record).

The effective period field 245 is a field for inputting the effective period of the master data (record) defined on the bills of materials definition screen 240.

The parent-child item start point field 246 (parent item) is a field for inputting the item name of a parent item among items in a parent-child relationship.

The parent-child item end point field 247 (child item) is a field for inputting the item name of a child item among items in a parent-child relationship.

The hierarchy field is a field for inputting the number of hierarchies of components of an item (television A in this example) specified by the item ID.

The number field is a field for inputting the quantity of the items indicated by the item name.

The inventory field is a field for inputting the inventory of the items indicated by the item name.

The add button is a button for adding (registering) the input information to the master data 620.

The update button is a button for updating the master data 620 with the input information.

The delete button is a button for canceling registration of the input information into the master data 620.

An item ID field, a date and time designation field 249, and a display button are provided above the component hierarchical structure area 248.

The item ID field is a field for inputting information corresponding to the item ID field of the item master table 621 illustrated in FIG. 11.

The date and time designation field 249 is a field for inputting the date and time desired to designate. When the date and time is designated, the hierarchical structure of the components at the designated date and time is displayed in the component hierarchical structure area 248. That is, the hierarchical structure of the components to be displayed changes depending on the designated date and time.

The display button is a button for displaying the hierarchical structure of components. When the display button is pressed after the date and time is designated, the hierarchical structure of the components defined at the time point of the designated date and time is displayed.

A feature of the bills of materials definition screen 240 is to include the effective period field 245, the version field 244, and the date and time designation field 249.

On the bills of materials definition screen 240 illustrated in FIG. 19, components constituting the television A are displayed in a 3-layer hierarchical structure in the component hierarchical structure area 248. “LIQUID CRYSTAL PANEL”, “SUBSTRATE”, and “COVER” are connected to a layer (second layer) below “TELEVISION A” (first layer), and “GLASS” is connected to a layer (third layer) below “LIQUID CRYSTAL PANEL”. In the figure, “×n” (n is a natural number) on the right side of the component indicates the number of components.

[Bills of Materials Definition Screen (Item) after Registration]

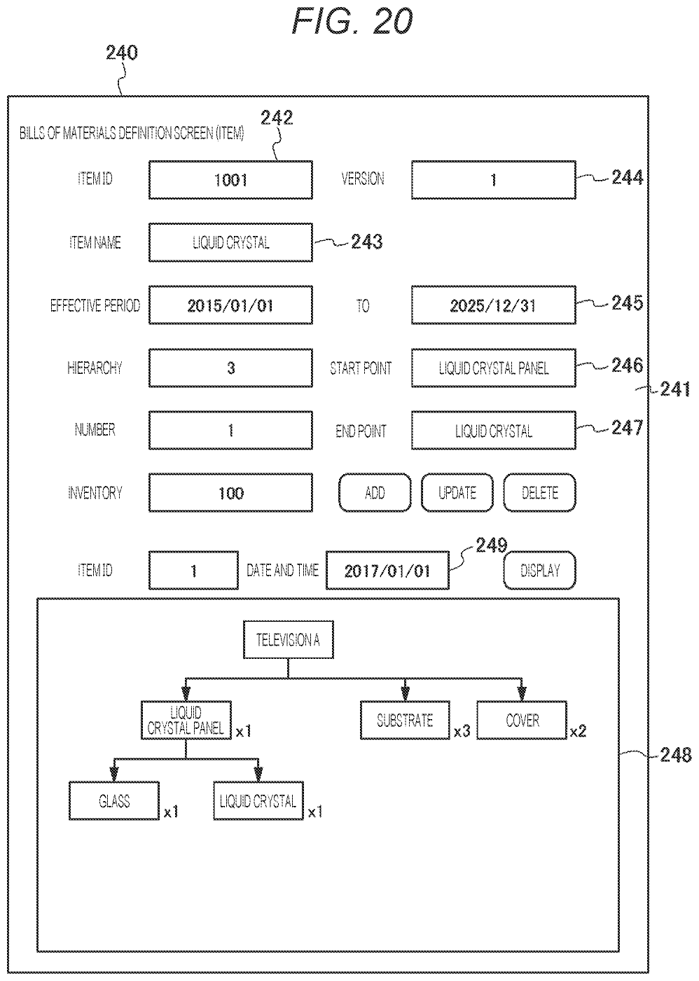

FIG. 20 illustrates an example of a screen (bills of materials definition screen 280) after registration of BOM management information.

When the add button is pressed in a state where the BOM management information illustrated in FIG. 19 is input onto the bills of materials definition screen 240, the content changes to the content of the bills of materials definition screen 240 illustrated in FIG. 20. Here, in the component hierarchical structure area 248, one “LIQUID CRYSTAL” is connected to the layer below “LIQUID CRYSTAL PANEL” in addition to “GLASS”.

This allows the manager 45 to confirm that “LIQUID CRYSTAL” has been added to the hierarchical structure of the components of the television A in the component hierarchical structure area 248 of the bills of materials definition screen 240.

[Bills of Materials Definition Screen (Item) after Designated Date and Time is Changed]

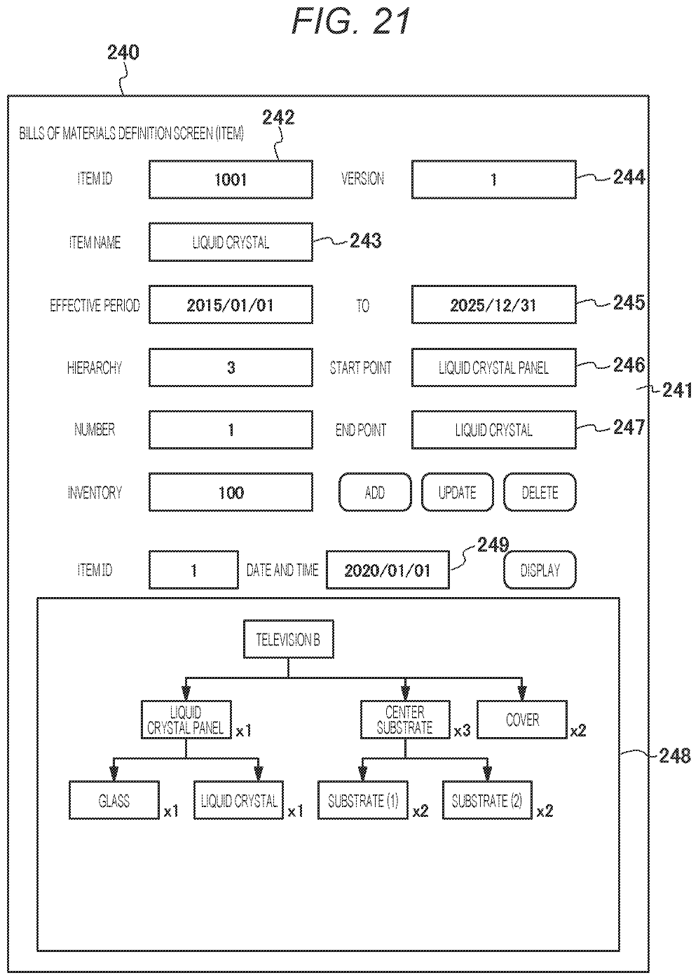

Next, a change in the display content of the screen after registration of the BOM management information due to the change of the designated date and time will be described with reference to FIG. 21.

FIG. 21 illustrates a change example of the display content of the screen (bills of materials definition screen) after registering BOM management information due to a change in designated date and time.

In the date and time designation field 249, the date and time to be designated is changed from “2017/01/01” to “2020/01/01”, and the display button is pressed. Due to this, the hierarchical structure of components associated with an effective period including “2020/01/01” is displayed. For example, in FIG. 21, the item is changed from “TELEVISION A” to “TELEVISION B” and the components of the television B are indicated in a 3-layer hierarchical structure. “LIQUID CRYSTAL PANEL”, “CENTER SUBSTRATE”, and “COVER” are connected to a layer (second layer) below “TELEVISION B” (first layer), “GLASS” and “LIQUID CRYSTAL” are connected to a layer (third layer) below “LIQUID CRYSTAL PANEL”, and “SUBSTRATE (1)” and “SUBSTRATE (2)” are connected to a layer (third layer) below “CENTER SUBSTRATE”.

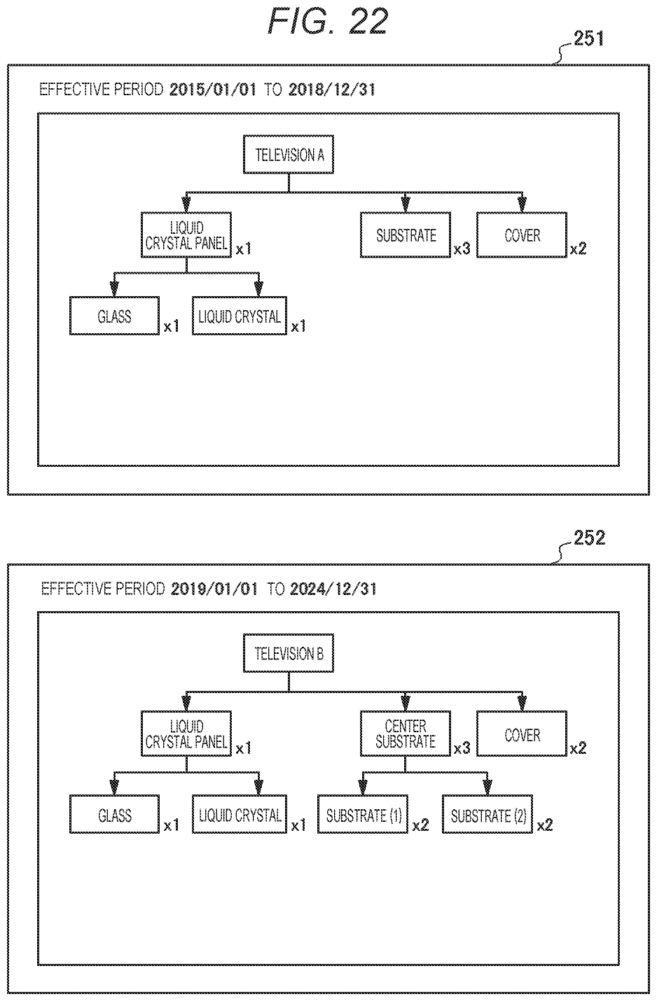

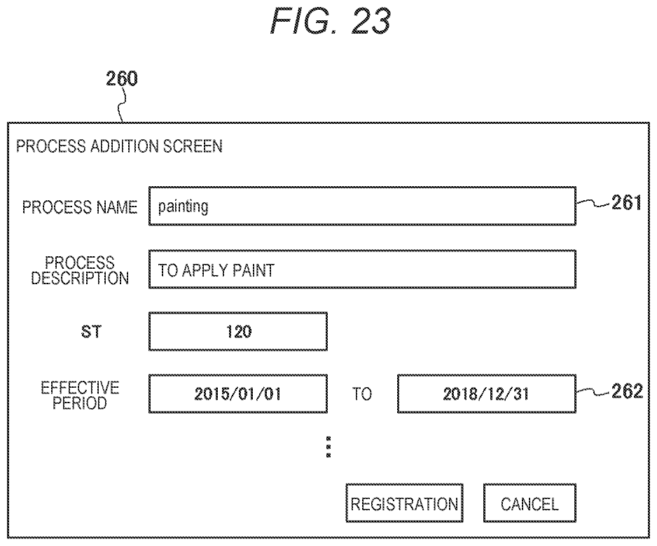

FIG. 22 illustrates an example of hierarchical structure data of components registered for each effective period.

The upper part of FIG. 22 illustrates hierarchical structure data 251 of the components with the effective period in 2015/01/01 to 2018/12/31. The lower part of FIG. 22 illustrates hierarchical structure data 252 of the components with the effective period in 2019/01/01 to 2024/12/31. Between the two effective periods, the item is changed from “TELEVISION A” to “TELEVISION B”, and “TELEVISION B” has an increased number of components than “TELEVISION A”. The hierarchical structure data of the components for each effective period is stored in the nonvolatile storage 57.

Thus, in the present embodiment, by having a function of setting an effective period to the master data and designating a date and time in the date and time designation field 249, it is possible to confirm the hierarchical structure of components at the designated date and time.

[Process Addition Screen]

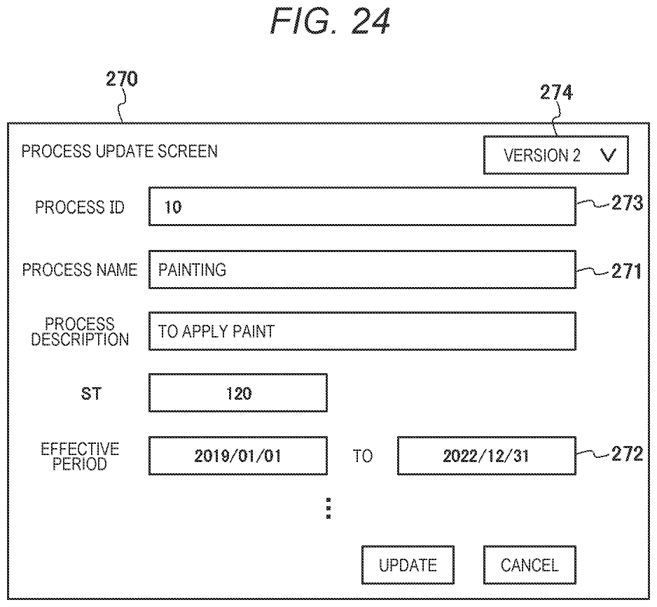

Next, a screen (process addition screen) for registering process data will be described with reference to FIG. 23.

FIG. 23 illustrates an example of a screen (process addition screen 260) for registering process data.

The process addition screen 260 includes a process name field 261 and an effective period field 262. In addition, the process addition screen 260 includes at least a process description field, a standard time (ST) field, a registration button, and a cancel button. The most characteristic feature of the process addition screen 260 is to include an effective period field 262.

The process name field 261 is a field for inputting the name of a process to be added.

The effective period field 262 is a field for inputting the effective period of the master data (record) to be registered on the process addition screen 260.

The process description field is a field for inputting the description of a process indicated by the process name.

The ST field is a field for inputting work time required to complete a target process.

By executing the flowchart of FIG. 14 using the process addition screen 260, the master data registration section 210 stores the input master data information (process data) into the master data 620 in the business data storage section 600.

[Process Update Screen]

Next, a screen (process update screen) for updating process data will be described with reference to FIG. 24.

FIG. 24 illustrates an example of a screen (process update screen 270) for updating process data.

The process update screen 270 includes at least a process ID field 273 and a version field 274 in addition to the configuration of the process addition screen 260. The process update screen 270 includes an update button instead of a registration button. A feature of the process update screen 270 is to include a version field 274 and an effective period field 272.

A process name field 271 is the same as the process name field 261.

The effective period field 272 is a field for inputting the effective period of the master data (record) updated on the process update screen 270.

The process ID field 273 is a field for inputting information corresponding to the process ID field of the process master table 622 illustrated in FIG. 11. In the process master table 622, the process ID “10” indicates “painting” or “PAINTING”. In the present embodiment, the process addition screen 260 does not display the process ID, but the process update screen 270 displays the process ID.

The version field 274 is a field for inputting the version of the present data (record).

By executing the flowchart of FIG. 17 using the process update screen 270, the master data registration section 210 updates the master data 620 in the business data storage section 600 with the input master data information (process data).

[Bills of Materials Definition Screen (Process) Before Registration]

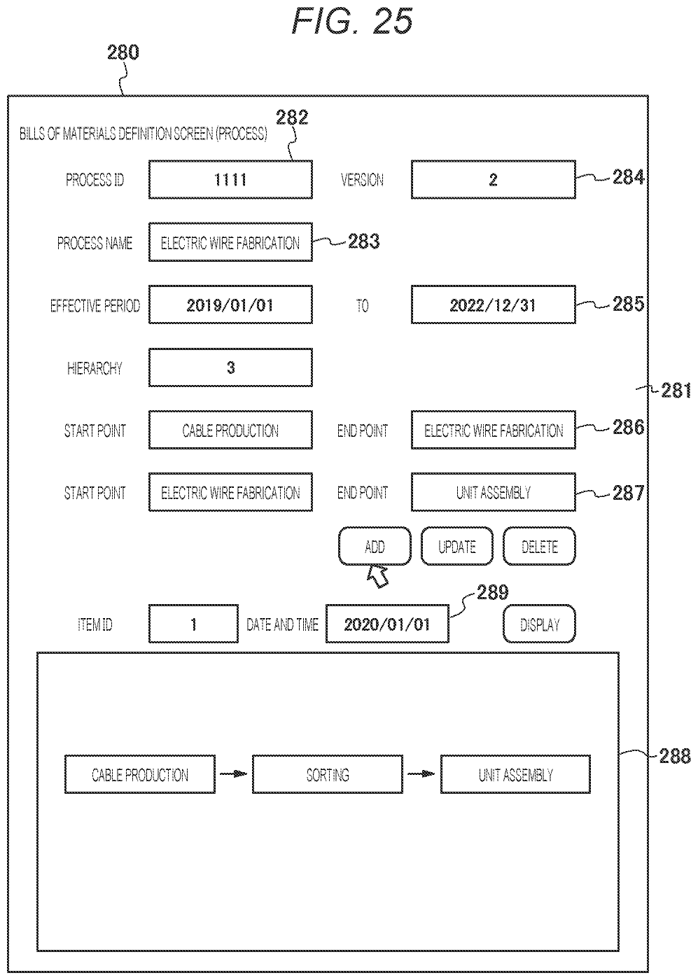

Next, a screen (bills of materials definition screen) for registering a process branch will be described with reference to FIG. 25.

FIG. 25 illustrates an example of a screen (bills of materials definition screen 280) for registering a process branch.

The bills of materials definition screen 280 has a process management information area 281 in the upper part of the screen and a process hierarchical structure area 288 indicating a process procedure in the lower part of the screen.

The process management information area 281 is an area for displaying information for managing a process of manufacturing an item (product).

The process hierarchical structure area 288 is an area for displaying the hierarchical structure of the process.

The process management information area 281 includes a process ID field 282, a process name field 283, a version field 284, an effective period field 285, an upstream-side parent-child process field 286, and a downstream-side parent-child process field 287. In addition, the process management information area 281 includes a hierarchy field, an add button, an update button, and a delete button.

The process ID field 282 is a field into which information of “PARENT PROCESS ID+CHILD PROCESS ID” of the sequence master table 624 illustrated in FIG. 11 is input.

The process name field 283 is a field for inputting the name of a process subjected to definition.

The version field 284 is a field for inputting the version of the present data (record).

The effective period field 285 is a field for inputting the effective period of the master data (record) defined on the bills of materials definition screen 280.

The upstream-side parent-child process field 286 is a field for inputting the process names of a start point and an end point of an upstream-side path among the paths constituting the branch process. The process name of this start point is the name of a process specified by the parent process ID of the sequence master table 624 (FIG. 11), and the process name of the end point is the name of a process specified by the child process ID of the sequence master table 624.

The downstream-side parent-child process field 287 is a field for inputting the process names of a start point and an end point of a downstream-side path among the paths constituting the branch process. The process name of this start point is the name of a process specified by the parent process ID of the sequence master table 624 (FIG. 11), and the process name of the end point is the name of a process specified by the child process ID of the sequence master table 624.

The hierarchy field is a field for inputting the number of hierarchies of the processes specified by the process ID 282.

An item ID field, a date and time designation field 289, and a display button are provided above the process hierarchical structure area 288.

The item ID field is a field for inputting information corresponding to the item ID field of the item master table 621 illustrated in FIG. 11.

The date and time designation field 289 is a field for inputting the date and time desired to designate. When the date and time is designated, the hierarchical structure of the processes at the designated date and time is displayed in the process hierarchical structure area 288. That is, the hierarchical structure of the processes to be displayed changes depending on the designated date and time.

The display button is a button for displaying the hierarchical structure of processes. When the display button is pressed after the date and time is designated, the hierarchical structure of the processes defined at the time point of the designated date and time is displayed.

On the bills of materials definition screen 280 illustrated in FIG. 25, the process hierarchical structure area 288 displays a 3-layer hierarchical structure as processes indicated by the upstream-side parent-child process field 286 and the downstream-side parent-child process field 287. That is, “SORTING” is set in a downstream process (second layer) of “CABLE PRODUCTION” (first layer), and “UNIT ASSEMBLY” is set in a downstream process (third layer) of “SORTING”.

[Bills of Materials Definition Screen (Process) after Registration]

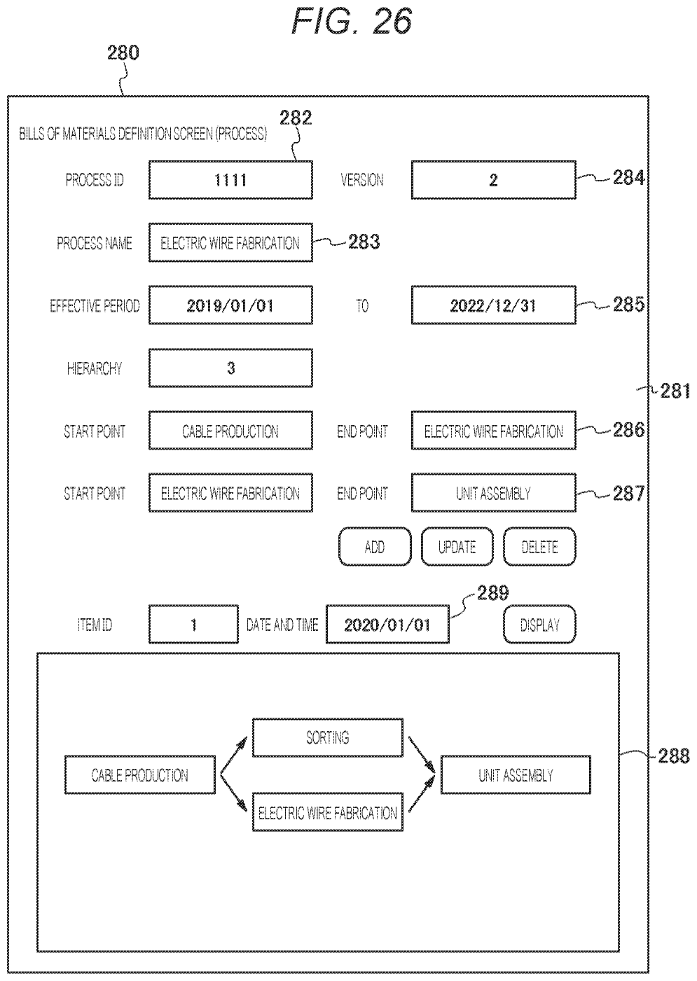

FIG. 26 illustrates an example of a screen (bills of materials definition screen 280) after registering the process branch.

When the add button is pressed in a state where the process management information illustrated in FIG. 25 is input onto the bills of materials definition screen 280, the content changes to the content of the bills of materials definition screen 280 illustrated in FIG. 26. Here, the process hierarchical structure area 288 displays a state of branching into “SORTING” and “ELECTRIC WIRE FABRICATION” as a downstream process of “CABLE PRODUCTION”. Then, after “SORTING” and “ELECTRIC WIRE FABRICATION”, the process merges with the process of “UNIT ASSEMBLY”.

This allows the manager 45 to confirm that the process of “ELECTRIC WIRE FABRICATION” is branched separately from “SORTING” between “CABLE PRODUCTION” and “UNIT ASSEMBLY” in the process hierarchical structure area 288 of the bills of materials definition screen 280.

[Bills of Materials Definition Screen (Process) after Designated Date and Time is Changed]

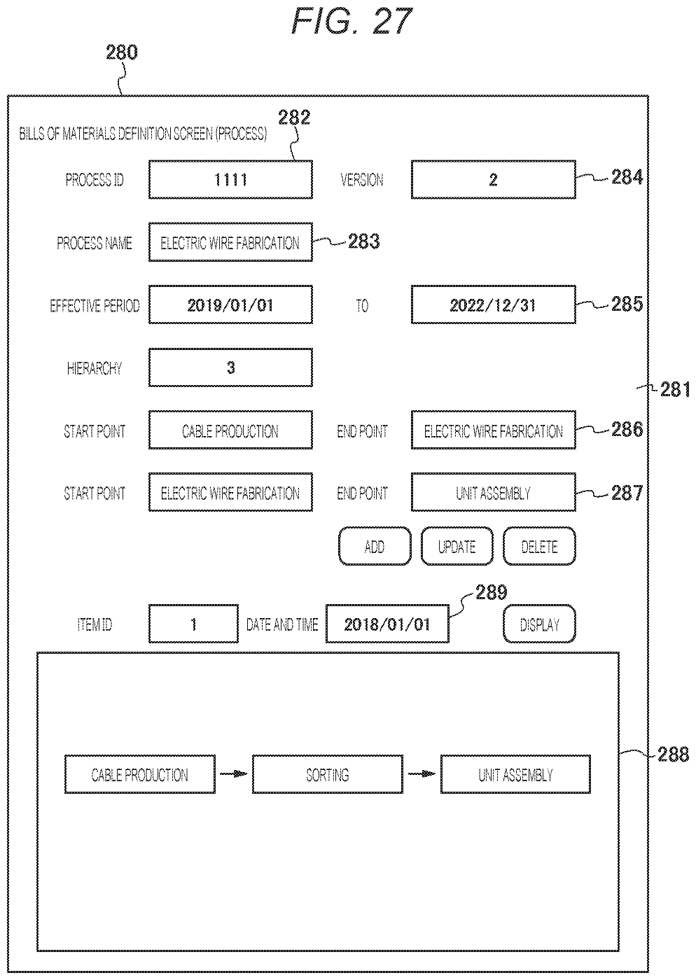

Next, a change in the display content of the screen after registration of the process branch due to the change of the designated date and time will be described with reference to FIG. 27.

FIG. 27 illustrates a change example of the display content of the screen (bills of materials definition screen) after registering a process branch due to a change in designated date and time.

In the date and time designation field 289, the date and time to be designated is changed from “2020/01/01” to “2018/01/01”, and the display button is pressed. Due to this, the hierarchical structure of processes associated with an effective period including “2018/01/01” is displayed. For example, in FIG. 27, a process having a three-layer hierarchical structure is illustrated by one path. That is, the sequence of “CABLE PRODUCTION”, “SORTING”, and “UNIT ASSEMBLY” is displayed. This is the hierarchical structure of the process before adding the branch process illustrated in FIG. 25.

The hierarchical structure data of the processes for each effective period is stored in the nonvolatile storage 57.

[Display Example of Business Data]

Next, screen display when the business application 730 acquires data from the performance data management device 200 through the business ETL 710 will be described.

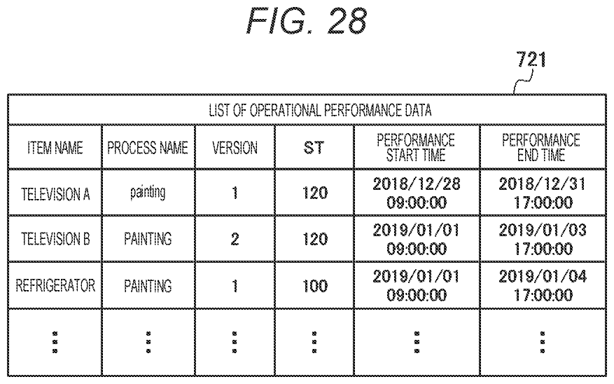

FIG. 28 illustrates an example of screen display when the business application 730 acquires data from the performance data management device 200. FIG. 28 illustrates a business performance data list 721 stored in the business data storage section 720 and accessed by the business application 730. The business performance data list 721 is an example of data accessed by the business application 730 according to the purpose, and is not limited to this example.

The business performance data list 721 is created by the business ETL 710 and is displayed in a table format. The business performance data list 721 has an item name field, a process name field, a version field, an ST field, a performance start time field, and a performance end time field.

The item name field indicates the name of the item specified by the item ID of the actual process table 611 (FIG. 12).

The process name field indicates the name of the process specified by the process ID of the actual process table 611 (FIG. 12). The business ETL 710 acquires the names of the item name field and the process name field from the master data 620 in the business data storage section 600.

The version field indicates the version of master data updated on the item update screen 230 (FIG. 18), for example.

The ST field indicates the time in the ST field displayed on the process addition screen 260 or the process update screen 270.

The performance start time field indicates the performance start time of the actual process table 611 (FIG. 12), the time at which the process is actually started.

The performance end time field indicates the performance end time of the actual process table 611 (FIG. 12), the time at which the process is actually ended.

In the first record of the business performance data list 721, the item name is “TELEVISION A”, the process name is “painting”, the version is “1”, the ST is “120”, the performance start time is “2018/12/28 09:00:00”, and the performance end time is “2018/12/31 17:00:00”. In the second record, the item name is “TELEVISION B”, the process name is “PAINTING”, the version is “2”, the ST is “120”, the performance start time is “2019/01/01 09:00:00”, and the performance end time is “2019/01/03 17:00:00”.

Thus, since (the effective period of) the data read from the master data 620 is different depending on the performance start time and the performance end time, the item name changes from the television A to the television B. In the present example, since the data read from the master data 620 is different, the process name, the version, and the ST are also changed.

As described above, the performance data management device 200 according to the first embodiment of the present invention includes: the performance data processing section 310 that receives the performance data 110 generated by the manufacturing site system 1; the performance data storage section 410 that stores and accumulates the performance data 110 received by the performance data processing section 310; the master data storage section (business data storage section 600) that stores the master data 620 has data to be basic information when the performance data 110 is managed; the business data generation section 500 that generates business data (performance data 610) by processing the performance data 110 into a structure used by the business application 730 based on data (data item and field) to be the basic information of the master data 620; and the business data storage section 600 that stores the business data generated by the business data generation section 500. Then, the master data 620 includes an attribute that represents start of an effective period of data to be the basic information (effective period start date) and an attribute that represents end of an effective period (effective period start date).

In the present embodiment configured as described above, it is possible to ensure consistency of related data by the attribute of this effective period even if the content of the performance data of the manufacturing site system is changed.

When the business performance data list 721 is viewed through the business application 730, the effective period of the data is not displayed. Therefore, the user can use the performance data without being conscious of the effective period of the data.

In the performance data management device 200 according to the first embodiment of the present invention described above, the business data generation section 500 generates business data from performance data on the basis of the effective period of the data to be the basic information of the master data.

In the performance data management device 200 according to the first embodiment of the present invention described above, the business data generation section 500 determines whether an invalid value has been set in the performance data 110 on the basis of the effective period of the data to be the basic information of the master data.

The performance data management device 200 according to the first embodiment of the present invention described above includes the master data registration section 210 that registers the master data 620 into the master data storage section (business data storage section 600) in accordance with an instruction from the operation section 56. When registering master data, the master data registration section 210 invalidates the value instructed from the operation section 56 in a case where the value of the effective period instructed from the operation section 56 is an invalid value as an effective period.

In the performance data management device 200 according to the first embodiment of the present invention described above, when registering the master data, the master data registration section 210 outputs an error in a case where the value of the effective period instructed from the operation section 56 is an invalid value as an effective period.

In the performance data management device 200 according to the first embodiment of the present invention described above, when registering the master data, the master data registration section 210 displays, on the display section 55, a registration screen (the item addition screen 220 or the process addition screen 260) representing the hierarchical structure of components or processes necessary for assembly of the item to be manufactured.

In the performance data management device 200 according to the first embodiment of the present invention described above, the master data 620 has data to be the basic information in which an effective period is set for each component necessary for assembly of the item to be manufactured.

In the performance data management device 200 according to the first embodiment of the present invention described above, in a case where the master data 120 including data to be the basic information when managing the performance data 110 is acquired from the manufacturing site system 1, the business data generation section 500 determines whether to register the master data 120 on the basis of a state of the flag (update/delete flag 122) for registering or updating the master data 120 included in the acquired master data 120 into the master data storage section (business data storage section 600).

### Second Embodiment

In general, as four elements of production, resources used in business can be classified into so-called 4M, i.e., man, machine, material, and method. Then, business is analyzed from the viewpoint of the four elements of production in order to achieve key performance indicator (KPI) targeted by a management organization.

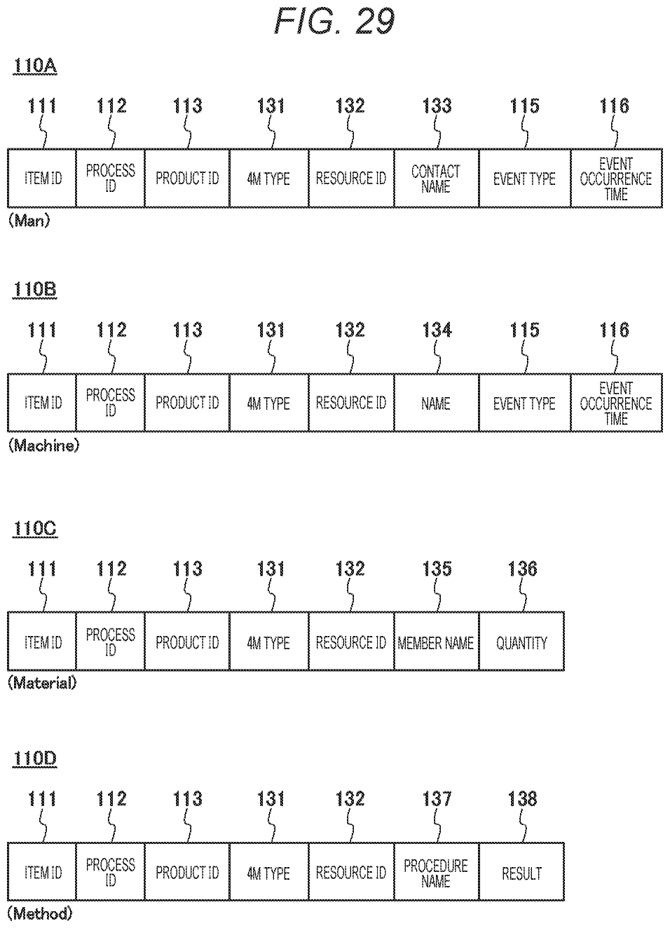

FIG. 29 illustrates a configuration example of performance data classified into four elements of production according to the second embodiment of the present invention.

As the types of the performance data, FIG. 29 illustrates performance data 110A where a man is a resource, performance data 110B where a machine is the resource, performance data 110C where a material is the resource, and performance data 110D where a method is the resource.

(Man)

As attributes (data items), the performance data 110A includes a 4M type 131, a resource ID 132, and a contact name 133, for example, in addition to the item ID 111, the process ID 112, the product ID 113, the event type 115, and the event occurrence time 116.

The 4M type 131 stores information indicating the type of resource for use in practice of business (generating performance data). In the present embodiment, it is indicated which element in the 4M of production the performance data belongs to. This 4M type information makes it possible to sort the performance data for each of the 4M type.

The resource ID 132 stores a resource ID corresponding to a resource name (in charge of painting, in charge of drying, and the like) defined by master data not illustrated. In this master data, a relationship between business and resources associated with the business is defined.

The contact name 133 stores the name of the person in charge of work engaged in business as information indicating details of the resource.

(Machine)

As attributes (data items), the performance data 110B includes the 4M type 131, the resource ID 132, and a name 134, for example, in addition to the item ID 111, the process ID 112, the product ID 113, the event type 115, and the event occurrence time 116.

The resource ID 132 stores a resource ID corresponding to a resource name (painting device, drying device, and the like) defined by master data not illustrated.

The name 134 stores the name of the machine used for business as information indicating details of the resource.

(Material)

As attributes (data items), the performance data 110C includes the 4M type 131, the resource ID 132, a member name 135, and a quantity 136, for example, in addition to the item ID 111, the process ID 112, and the product ID 113.

The resource ID 132 stores a resource ID corresponding to a resource name (members, components, materials, and the like) defined by master data not illustrated.

The member name 135 stores the names of members (components), materials, and the like used or produced in business as information indicating details of the resource.

As information indicating performance, the quantity 136 stores information indicating an increase or decrease from a set value (initial number, target number, or the like) of the quantity of a target member, for example. This may be a value of the quantity of a target member.

(Method)

As attributes (data items), the performance data 110D includes the 4M type 131, the resource ID 132, a procedure name 137, and a result 138, for example, in addition to the item ID 111, the process ID 112, and the product ID 113.

The resource ID 132 stores a resource ID corresponding to a resource name (methods, procedures, and the like) defined by master data not illustrated.

The procedure name 137 stores the name of the method (procedure) used in business as information indicating details of the resource.

As information indicating performance, the result 138 stores information on a result (good, not good, or the like) of execution of a method instructed in business.

In the second embodiment described above, an example in which performance data (resource) is classified into four elements of production has been described, but it may be classified into three elements or two elements of the four elements. Alternatively, performance data (resource) may be classified into a type of elements different from the four elements of production.

The present invention is not limited to the first and second embodiments described above, and can be applied to general systems such as FA systems and process automation (PA) systems. The present invention is suitably applied to a system in which a start time and an end time of a process, a work, or the like are obtained as performance data.

Furthermore, the present invention is not limited to each of the above-described embodiments, and it goes without saying that various other application examples and modifications can be taken without departing from the gist of the present invention described in the claims.

For example, each of the above-described embodiments is described with the configuration of the performance data management device in detail and specifically in order to describe the present invention in an easy-to-understand manner, and the present invention is not necessarily limited to those including all the constituent elements described above. A part of the configuration of an embodiment can be replaced with a constituent element of another embodiment. A constituent element of another embodiment can be added to the configuration of an embodiment. Another constituent element can be added to, replaced with, or deleted from a part of the configuration of each embodiment.

The above-described configurations, functions, processing sections, and the like may be partially or entirely implemented by hardware by designing with an integrated circuit, for example. A field programmable gate array (FPGA), an application specific integrated circuit (ASIC), or the like may be used as the hardware.

Each constituent element of the performance data management device according to the first and second embodiments described above may be implemented in any hardware as long as each piece of the hardware can transmit and receive information to and from one another via a network. The processing performed by a certain processing section may be implemented by one piece of hardware or may be implemented by distributed processing by a plurality of pieces of hardware.

### REFERENCE SIGNS LIST

110 performance data
120 master data
127 data effective period start date
128 data effective period end date
200 performance data management device
210 master data registration section
220 item addition screen
230 item update screen
240 bills of materials definition screen (item)
241 BOM management information area
248 component hierarchical structure area
260 process addition screen
270 process update screen
280 bills of materials definition screen (process)
288 process hierarchical structure area
310 performance data processing section
320 master data processing section
410 performance data storage section
420 master data storage section
500 business data generation section
600 business data storage section
610 performance data
611 actual process master table
620 master data
621 item master table
622 process master table
623 BOM master table
624 sequence master table
730 business application
1000 business management system

1. A performance data management device, comprising:
a performance data processing section that receives performance data generated by a manufacturing site system;
a performance data storage section that stores and accumulates the performance data received by the performance data processing section;
a master data storage section that stores master data that has data to be basic information when the performance data is managed;
a business data generation section that generates business data by processing the performance data into a structure used by a business application based on data to be the basic information in the master data; and
a business data storage section that stores the business data generated by the business data generation section,
wherein the master data includes an attribute that represents start of an effective period of data to be the basic information and an attribute that represents end of the effective period.

2. The performance data management device according to claim 1, wherein
the business data generation section generates the business data from the performance data based on the effective period of data to be the basic information of the master data.

3. The performance data management device according to claim 2, wherein
the business data generation section determines whether an invalid value has been set in the performance data based on the effective period of data to be the basic information of the master data.

4. The performance data management device according to claim 3, comprising:
a master data registration section that registers the master data into the master data storage section in accordance with an instruction from an operation section,
wherein when registering the master data, the master data registration section invalidates a value instructed from the operation section in a case where a value of the effective period instructed from the operation section is an invalid value as an effective period.

5. The performance data management device according to claim 4, wherein
when registering the master data, the master data registration section outputs an error in a case where a value of the effective period instructed from the operation section is an invalid value as an effective period.

6. The performance data management device according to claim 5, wherein
when registering the master data, the master data registration section displays, on a display section, a registration screen representing a hierarchical structure of components or processes necessary for assembly of an item to be manufactured.

7. The performance data management device according to claim 1, wherein
the master data includes data to be the basic information in which the effective period is set for each component necessary for assembly of an item to be manufactured.

8. The performance data management device according to claim 1, wherein
in a case where master data including data to be basic information when managing the performance data is acquired from the manufacturing site system, the business data generation section determines whether to register the master data based on a state of a flag for registering or updating, into the master data storage section, the master data included in the master data having been acquired.

9. The performance data management device according to claim 1, wherein
types of the performance data include performance data where a man is a resource for use in practice of business, performance data where a machine is the resource, performance data where a material is the resource, and performance data where a method is the resource.

10. A business management system comprising: a performance data management device; and a business application that uses performance data managed by the performance data management device,
wherein the performance data management device includes
a performance data processing section that receives performance data generated by a manufacturing site system,
a performance data storage section that stores and accumulates the performance data received by the performance data processing section,
a master data storage section that stores master data that has data to be basic information when the performance data is managed,
a business data generation section that generates business data by processing the performance data into a structure used by the business application based on data to be the basic information in the master data, and a business data storage section that stores the business data generated by the business data generation section, and
the master data includes an attribute that represents start of an effective period of data to be the basic information and an attribute that represents end of the effective period.
